(19) United States
(12) Patent Application Publication
(10) Pub. No.: US 2024/0343614 A1
(43) Pub. Date: Oct. 17, 2024

(54) DEWATERING TRAILER SYSTEM

(71) Applicant: Bristola, LLC, Des Moines, IA (US)

(72) Inventor: Jared Burma, Waukee, IA (US)

(21) Appl. No.: 18/625,720

(22) Filed: Apr. 3, 2024

Related U.S. Application Data
(60) Provisional application No. 63/493,922, filed on Apr. 3, 2023.

(51) Int. Cl. C02F 1/38; B01D 21/26; B01D 33/15; C02F 1/00; C02F 11/127; C02F 103/00

(52) U.S. Cl. CPC C02F 1/385; B01D 33/15; C02F 1/004; C02F 11/127; B01D 21/267; C02F 2103/007; C02F 2201/008; C02F 2301/046

(57) ABSTRACT

In one or more arrangements, a system for separating solids and liquids from a pond, lagoon, tank, or other source of liquid is presented. In one or more arrangements, the system includes a robot cleaner, a trailer, and a dewatering system. In one or more arrangements, the dewatering system is configured to operably connect to the trailer and the robot cleaner is configured to fluidly connect to the dewatering system. In one or more arrangements, the robot cleaner is configured to pump solids and liquids from a source of liquid to the dewatering system and the dewatering system is configured to separate the solids from the liquids. In one or more arrangements, the dewatering system is configured to transfer separated solids away from the system and return the liquids to the source of liquid.

### CROSS-REFERENCE TO RELATED APPLICATIONS

This application claims priority to U.S. Provisional Application No. 63/493,922 entitled DEWATERING TRAILER SYSTEM and filed on Apr. 3, 2023, the entirety of which is hereby incorporated by reference herein, including any figures, tables, drawings, and other information.

### FIELD OF THE DISCLOSURE

This disclosure relates to a dewatering system. More specifically, this disclosure relates to a dewatering system that is mobile and removes solids and returns liquid to a tank, lagoon, pond, or similar liquid container.

### OVERVIEW OF THE DISCLOSURE

Many tanks, lagoons, ponds, or similar liquid containers are configured to hold both liquids and solid matter. In certain arrangements, such as in an anerobic digester tank or lagoon, solids are broken down by microorganisms which create gas and liquid. In various arrangements, these tanks, lagoons, ponds, or similar liquid containers can develop layers of solid materials which are stuck onto the bottom or floor of the tank, lagoon, pond, or similar liquid container. These layers of solid materials must be cleaned off or removed in order for the tank, lagoon, pond, or similar liquid container to meet certain health or cleanliness specifications and/or to just operate properly. In order to facilitate this, the systems may be drained, or the tank, pond, lagoon, or similar liquid container must be entirely drained and the material physically scraped off the floor or bottom, or the material may be suctioned off the bottom or floor of the tank, lagoon, pond, or similar liquid container.

When the material is suctioned off the bottom or floor, both solids and liquid are removed from the tank, pond, lagoon, or similar liquid container. Rather than waste the liquids, many organizations choose to separate the liquid from the solids and return the liquid to the tank, pond, lagoon, or similar liquid container. However, the available mechanisms to separate the liquid from the solid and return liquid to the tank, pond, lagoon, or similar liquid container are heavy and immovable, cumbersome, time consuming.

Therefore, for all the reasons stated above, and the reasons stated below, there is a need in the art for an improved dewatering system that is mobile and removes solids and returns liquid (with less than 1% total dissolved solids) to a tank, lagoon, pond, or similar liquid container. Thus, it is a primary objective of the disclosure to provide a dewatering trailer system that improves upon the state of the art.

Another objective of the disclosure is to provide a dewatering trailer system which is safe to operate.

Yet another objective of the disclosure is to provide a dewatering trailer system which is able to comply with road travel restrictions.

Another objective of the disclosure is to provide a dewatering trailer system which is easily and efficiently moved around to various locations.

Yet another objective of the disclosure is to provide a dewatering trailer system which is relatively easy to build.

Another objective of the disclosure is to provide a dewatering trailer system which is relatively friendly to build.

Yet another objective of the disclosure is to provide a dewatering trailer system which can be built relatively quickly and efficiently.

Another objective of the disclosure is to provide a dewatering trailer system which is easy to operate.

Yet another objective of the disclosure is to provide a dewatering trailer system which is relatively cost friendly to manufacture.

Another objective of the disclosure is to provide a dewatering trailer system which is relatively easy to transport.

Yet another objective of the disclosure is to provide a dewatering trailer system which is aesthetically appealing.

Another objective of the disclosure is to provide a dewatering trailer system which is robust.

Yet another objective of the disclosure is to provide a dewatering trailer system which is water resistant.

Another objective of the disclosure is to provide a dewatering trailer system which is relatively inexpensive.

Yet another objective of the disclosure is to provide a dewatering trailer system which is not easily susceptible to wear and tear.

Another objective of the disclosure is to provide a dewatering trailer system which has a long useful life.

Yet another objective of the disclosure is to provide a dewatering trailer system which is efficient to use and operate.

These and other objects, features, or advantages of the disclosure will become apparent from the specification, figures, and claims.

### SUMMARY OF THE DISCLOSURE

In one or more arrangements, a system for separating solids and liquids from a pond, lagoon, tank, or other source of liquid is presented. In one or more arrangements, the system includes a robot cleaner, a trailer, and a dewatering system. In one or more arrangements, the dewatering system is configured to operably connect to the trailer and the robot cleaner is configured to fluidly connect to the dewatering system. In one or more arrangements, the robot cleaner is configured to pump solids and liquids from a source of liquid to the dewatering system and the dewatering system is configured to separate the solids from the liquids. In one or more arrangements, the dewatering system is configured to transfer separated solids away from the system and return the liquids to the source of liquid.

In one or more arrangements, the solids flowing into the dewatering system includes total suspended solids and total dissolved solids. In one or more arrangements, the dewatering system separates all total suspended solids from the liquids and approximately 99% of total dissolved solids from the liquids. In one or more arrangements, the separated total suspended solids and total dissolved solids are transported away and the liquid flows to a holding tank.

In one or more arrangements, the robot cleaner is fluidly connected to the dewatering system by a hose. In one or more arrangements, the system creates a continuous loop feed.

In one or more arrangements, the dewatering system includes at least one separator configured to separate solids from the liquids. In one or more arrangements, the at least one separator is a rotary screen separator. In one or more arrangements, the at least one separator is a hydrocyclone. In one or more arrangements, the dewatering system includes a rotary screen separator and a hydrocyclone.

In one or more arrangements, the dewatering system is configured to operate at a rate of 600 gallons per minute.

In one or more arrangements, the separated solids are transported away by a conveyor belt.

### BRIEF DESCRIPTION OF THE FIGURES

FIG. 1 is a rear elevation view of a dewatering trailer system, in accordance with one or more arrangements; the system having a trailer, a separator assembly having at least one separator, and a second holding tank.

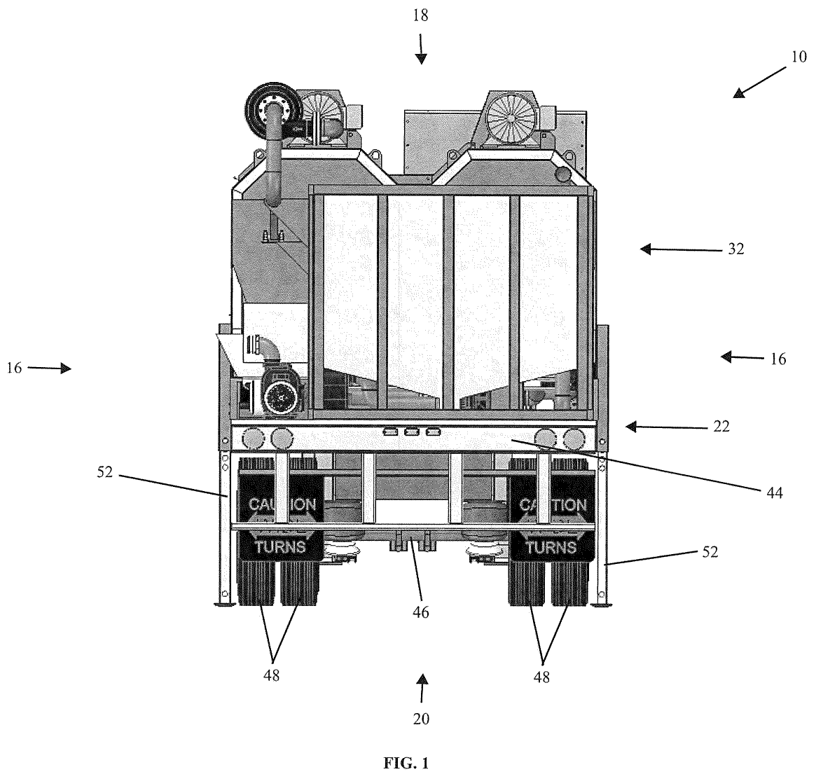

FIG. 2 is a perspective view of a dewatering trailer system, in accordance with one or more arrangements; the system having a trailer, an inlet assembly, a first holding tank, a separator assembly having a plurality of separators, a second holding tank, a hydrocyclone assembly, and waste disposal containers.

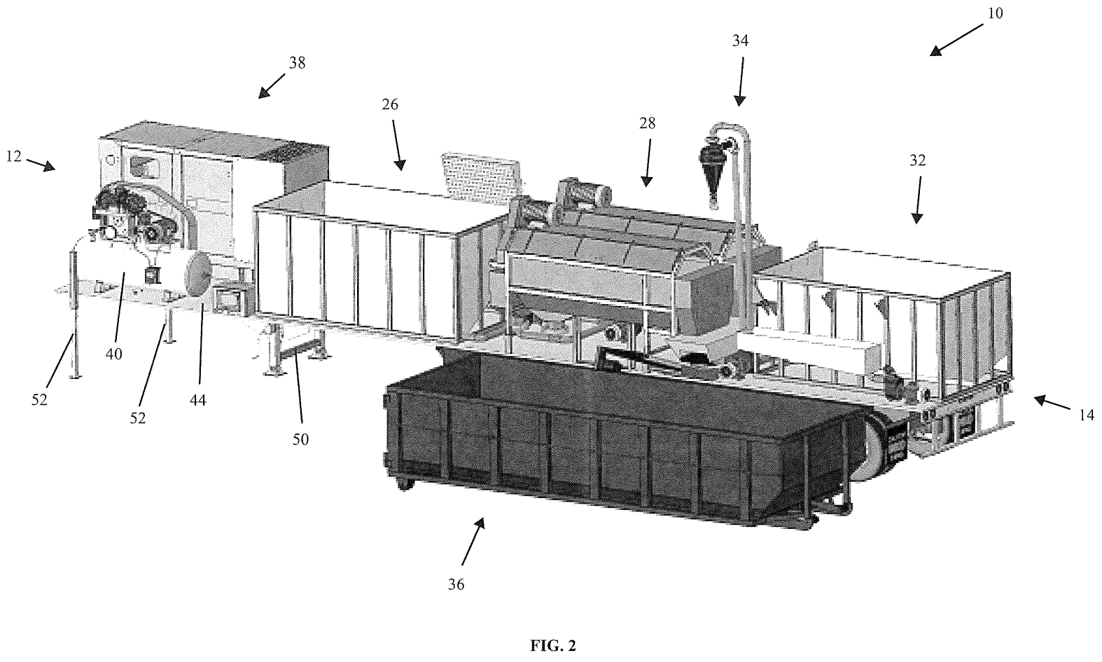

FIG. 3 is a perspective view of a dewatering trailer system, in accordance with one or more arrangements; the system having a trailer, a separator assembly having a plurality of separators, a second holding tank, a hydrocyclone assembly, and waste disposal containers.

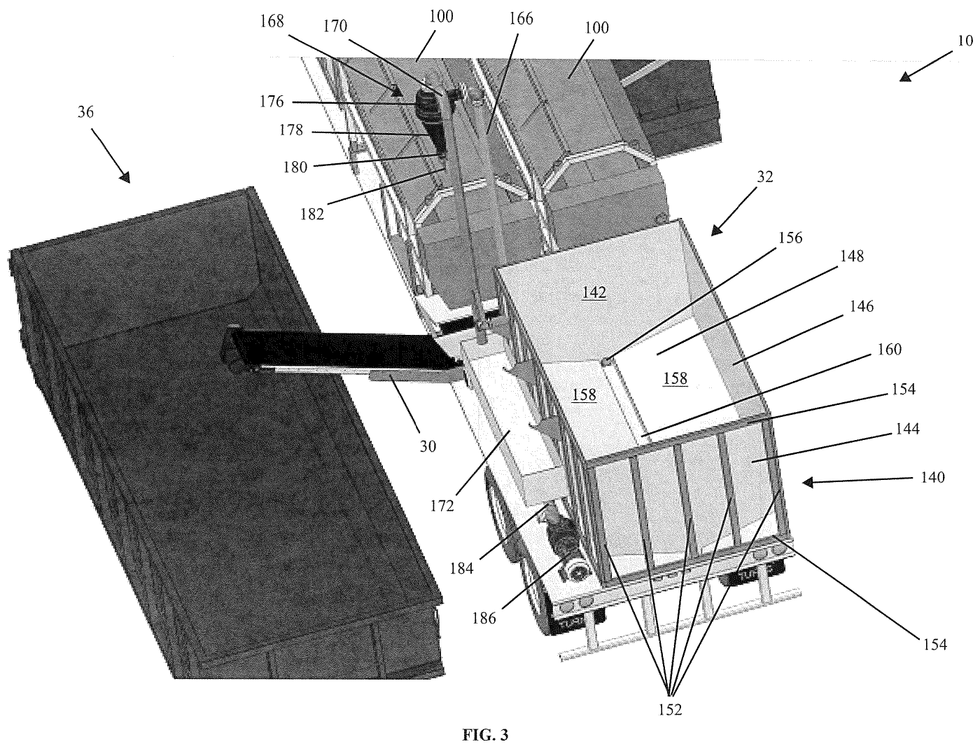

FIG. 4 is a perspective view of a dewatering trailer system, in accordance with one or more arrangements; the system having a trailer, a separator assembly having a plurality of separators, a second holding tank, a hydrocyclone assembly, and waste disposal containers.

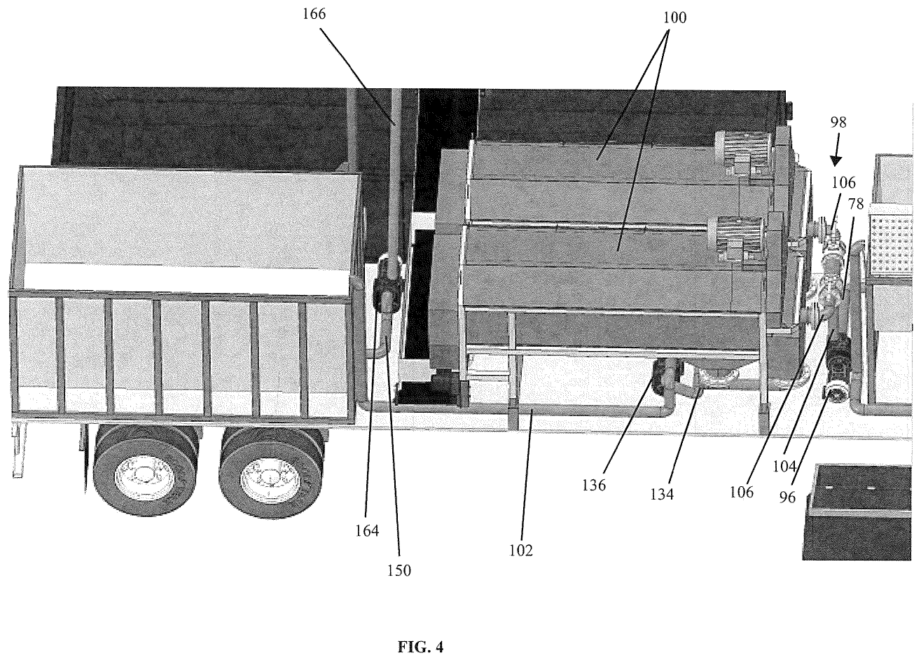

FIG. 5 is a perspective view of a dewatering trailer system, in accordance with one or more arrangements; the system having a trailer, a first holding tank, a separator assembly having a plurality of separators, a second holding tank, a hydrocyclone assembly, and waste disposal containers.

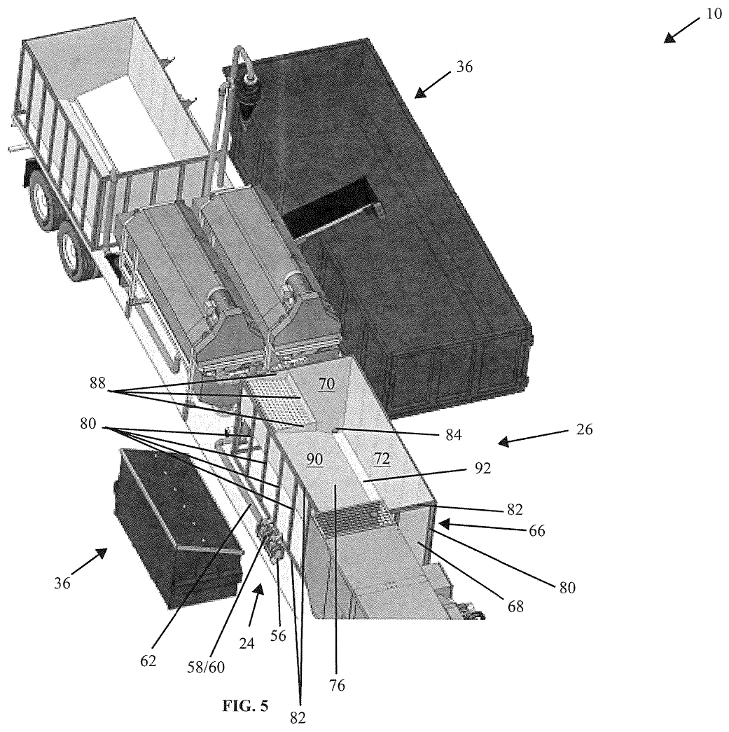

FIG. 6 is a perspective view of a dewatering trailer system, in accordance with one or more arrangements; the system having a trailer, an inlet assembly, a first holding tank, a separator assembly having a plurality of separators, a second holding tank, a hydrocyclone assembly, and a waste disposal container.

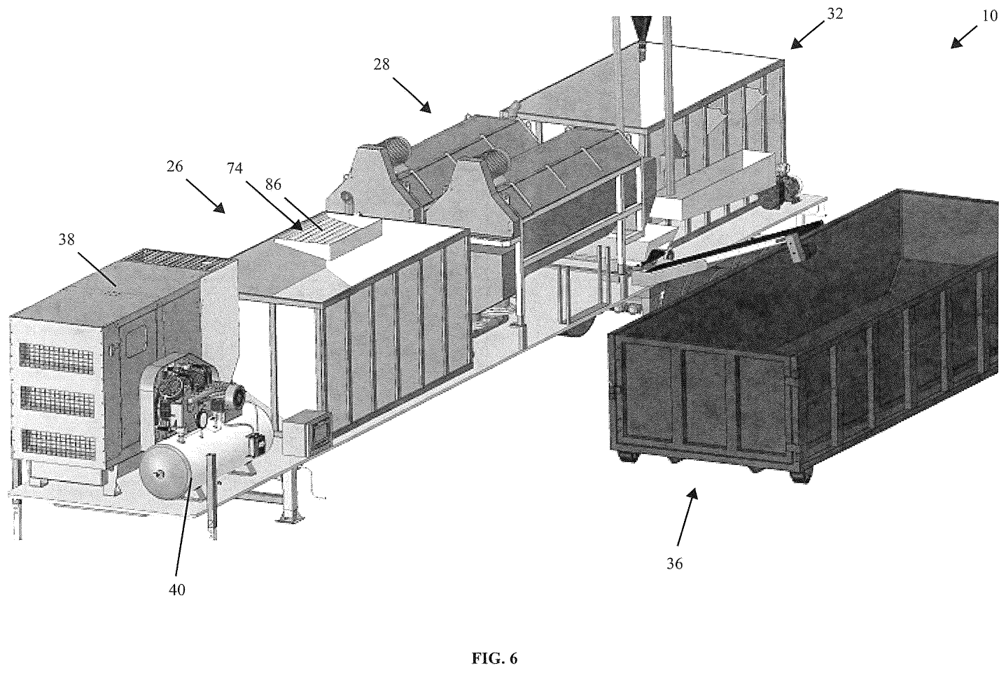

FIG. 7 is a perspective view of a dewatering trailer system, in accordance with one or more arrangements; the system having a trailer, an inlet assembly, a first holding tank, a separator assembly having a plurality of separators, a second holding tank, a hydrocyclone assembly, and a waste disposal container; the view showing the hydrocyclone assembly rotated such that it can be towed and meet road height restrictions.

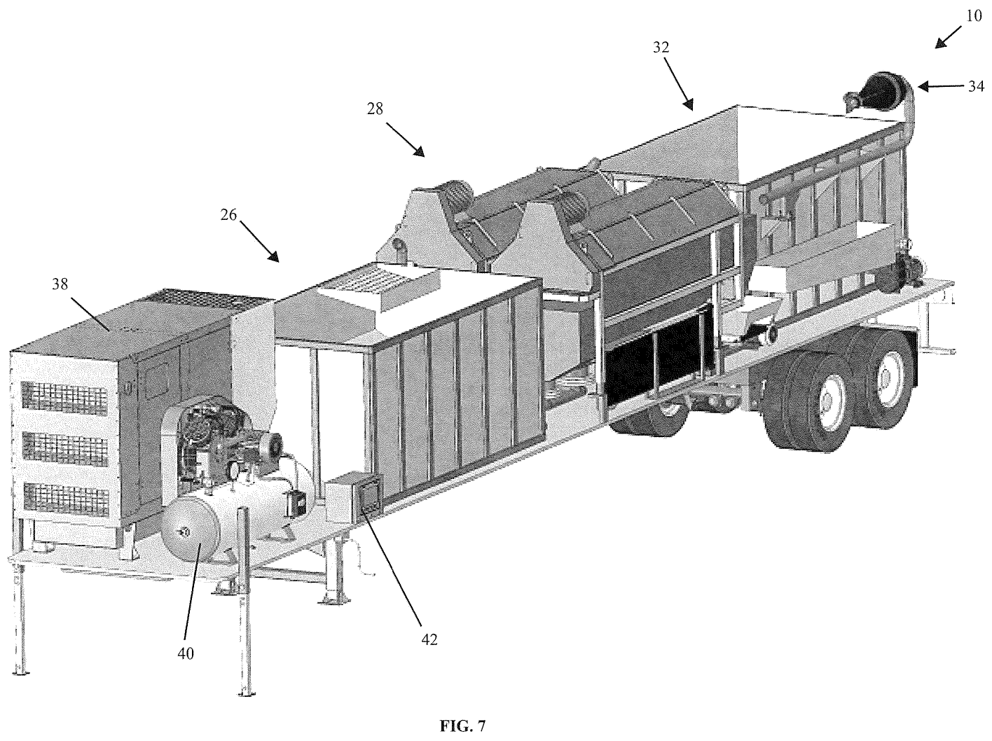

FIG. 8 is a perspective view of a dewatering trailer system, in accordance with one or more arrangements; the system having a trailer, a second holding tank, and a hydrocyclone assembly.

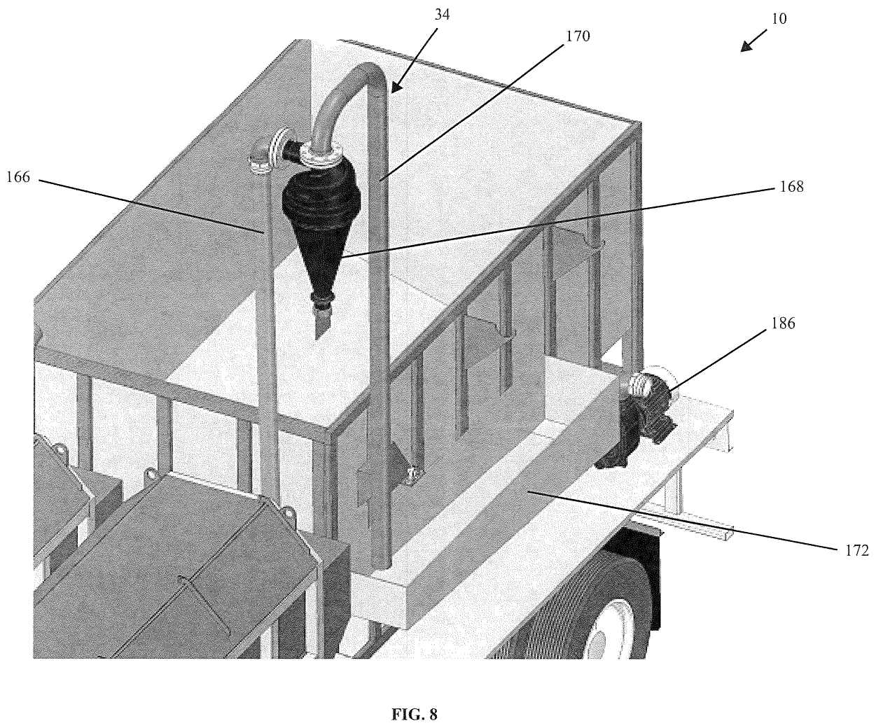

FIG. 9 is a perspective view of a separator; the view showing the separator having a housing with opposing sidewalls, an upper wall, a rotating member, and a drain pan; the view also showing the separator having a motor.

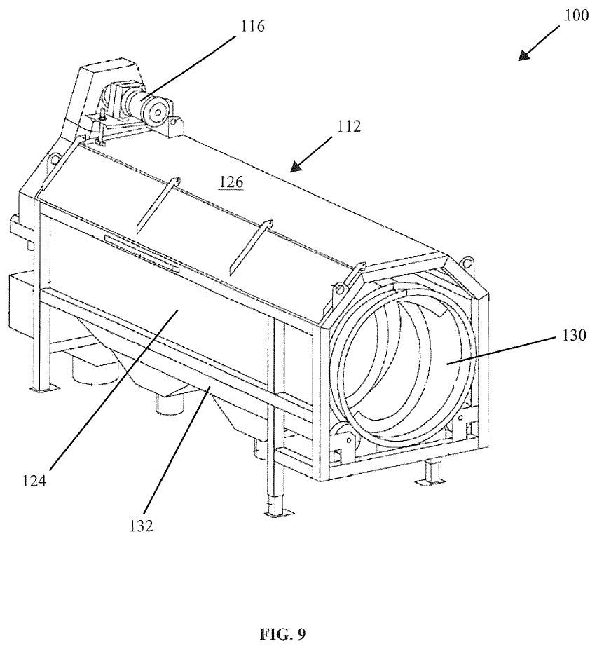

FIG. 10 is a side elevation view of a separator; the view showing the separator having a housing with a forward end, a rearward end, an upper wall, and a lower wall, a rotating member, and a drain pan; the view also showing the separator having an inlet pipe and a drive belt.

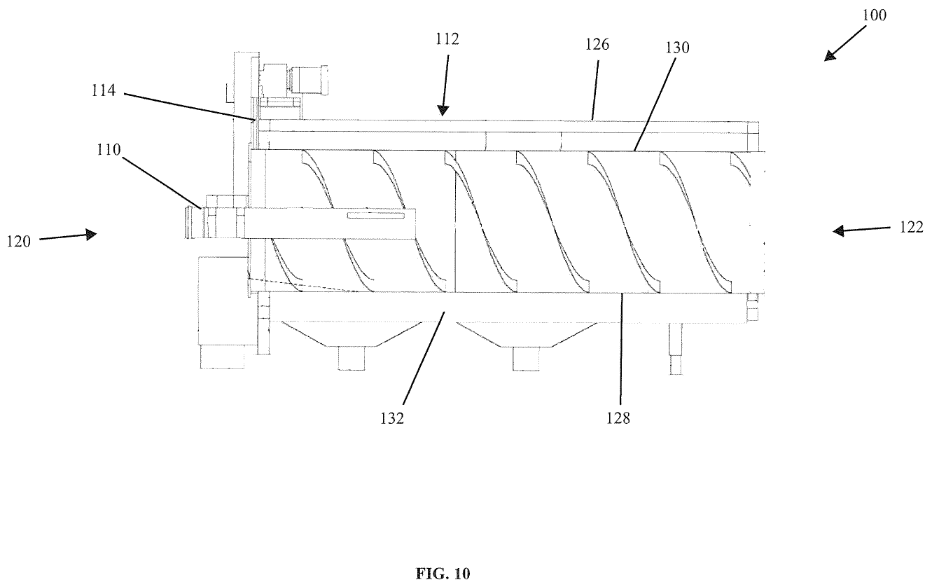

FIG. 11 is a perspective view of a dewatering trailer system, in accordance with one or more arrangements; the system having a trailer, a first holding tank, a separator, a second holding tank, and a hydrocyclone assembly.

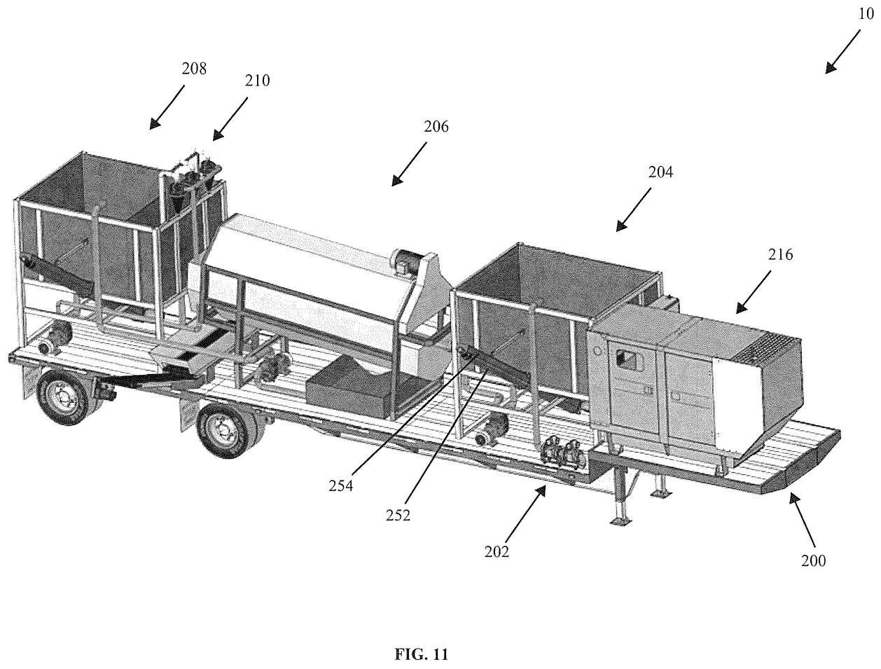

FIG. 12 is a rear elevation view of a dewatering trailer system, in accordance with one or more arrangements; the system having a trailer, a second holding tank, and a hydrocyclone assembly.

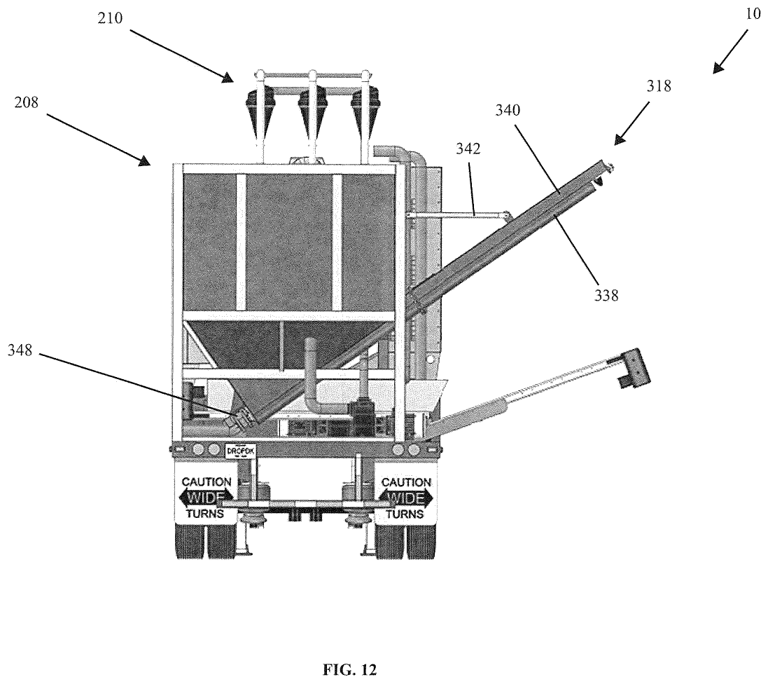

FIG. 13 is a side elevation view of a dewatering trailer system, in accordance with one or more arrangements; the system having a trailer, an inlet assembly, a first holding tank, a separator, a second holding tank, and a hydrocyclone assembly.

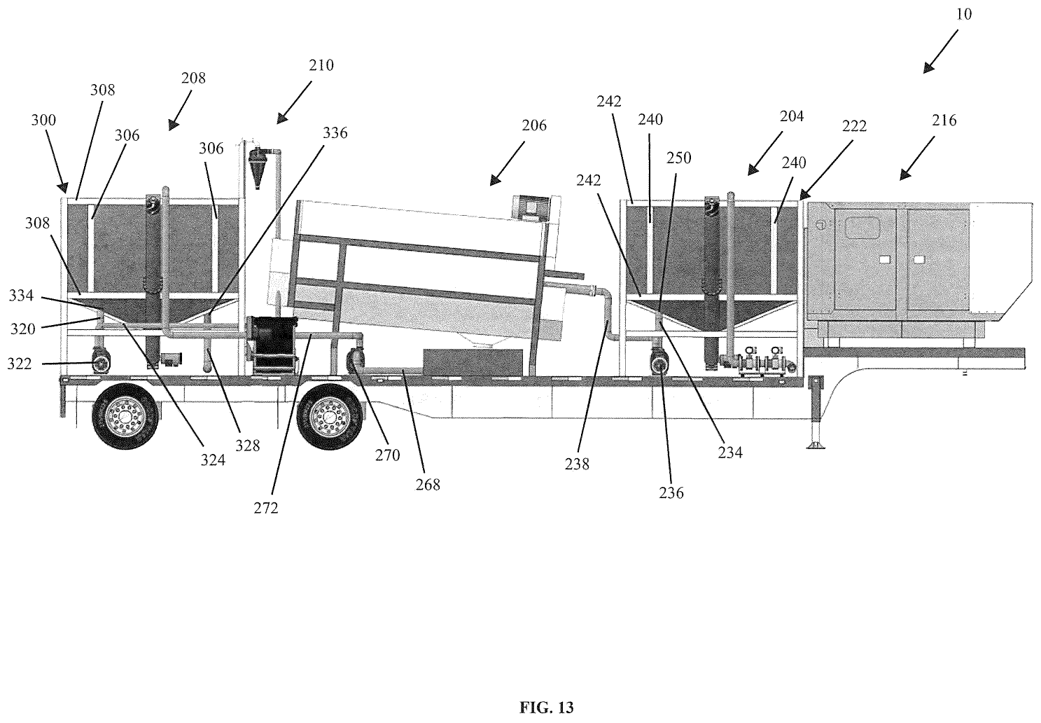

FIG. 14 is a perspective view of a dewatering trailer system, in accordance with one or more arrangements; the system having a trailer, a first holding tank, a separator, a second holding tank, and a hydrocyclone assembly.

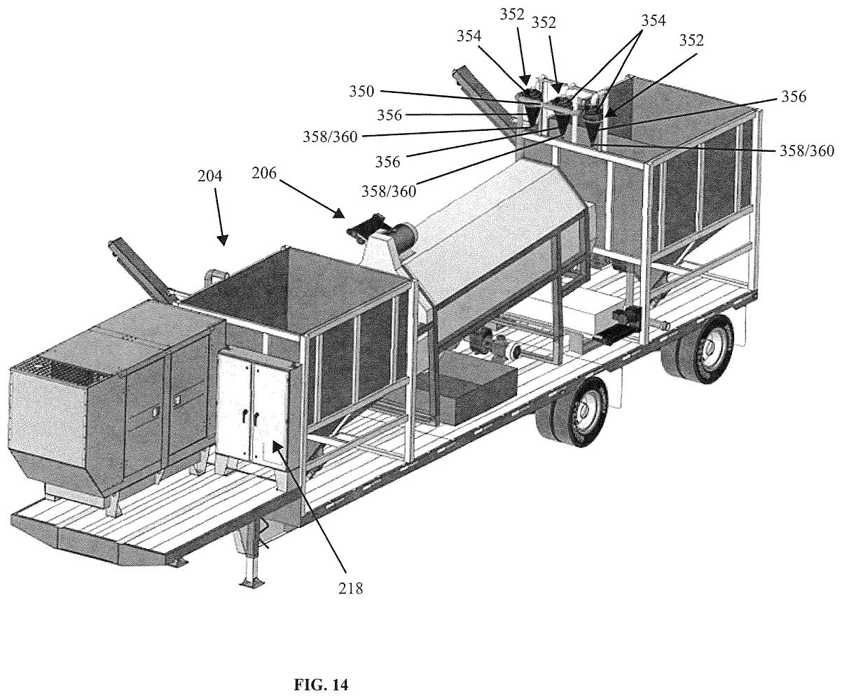

FIG. 15 is a perspective view of a dewatering trailer system, in accordance with one or more arrangements; the system having a trailer, a first holding tank, a separator, a second holding tank, a hydrocyclone assembly, and a waste disposal container.

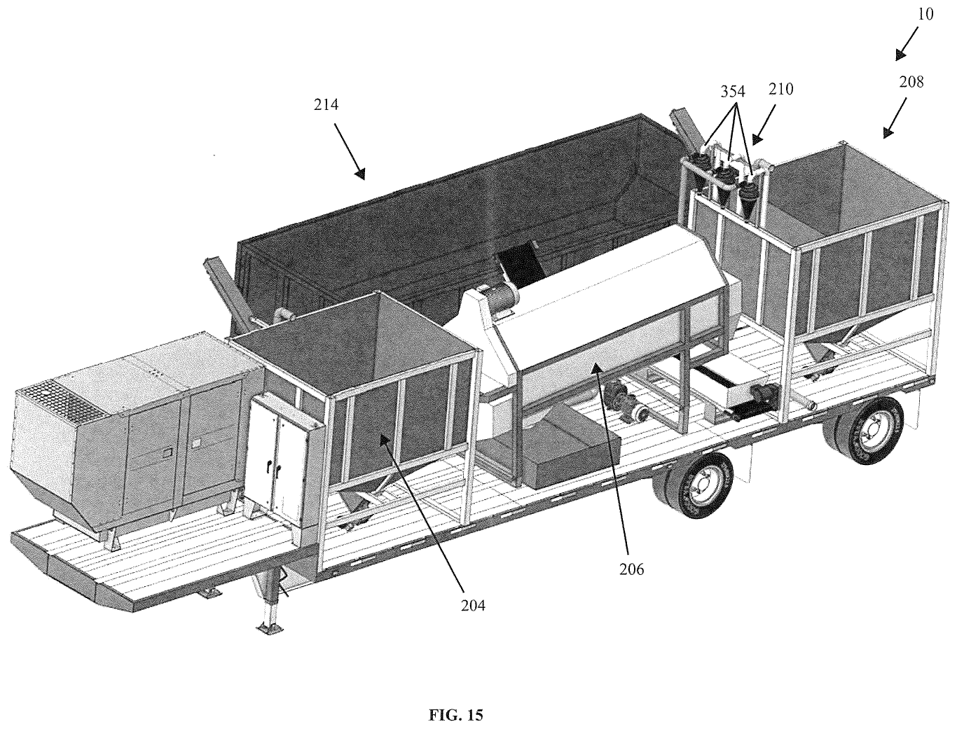

FIG. 16 is a perspective view of a first holding tank of a dewatering trailer system, in accordance with one or more arrangements; the first holding tank having an auger conveyor.

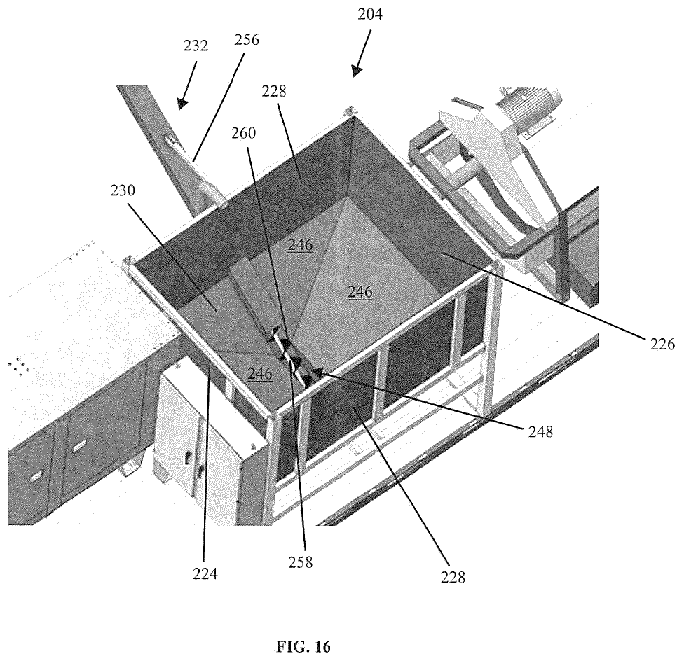

FIG. 17 is a perspective view of a second holding tank of a dewatering trailer system, in accordance with one or more arrangements; the second holding tank having a first portion with an auger conveyor and a second portion; the view also showing the dewatering trailer system having a hydrocyclone assembly.

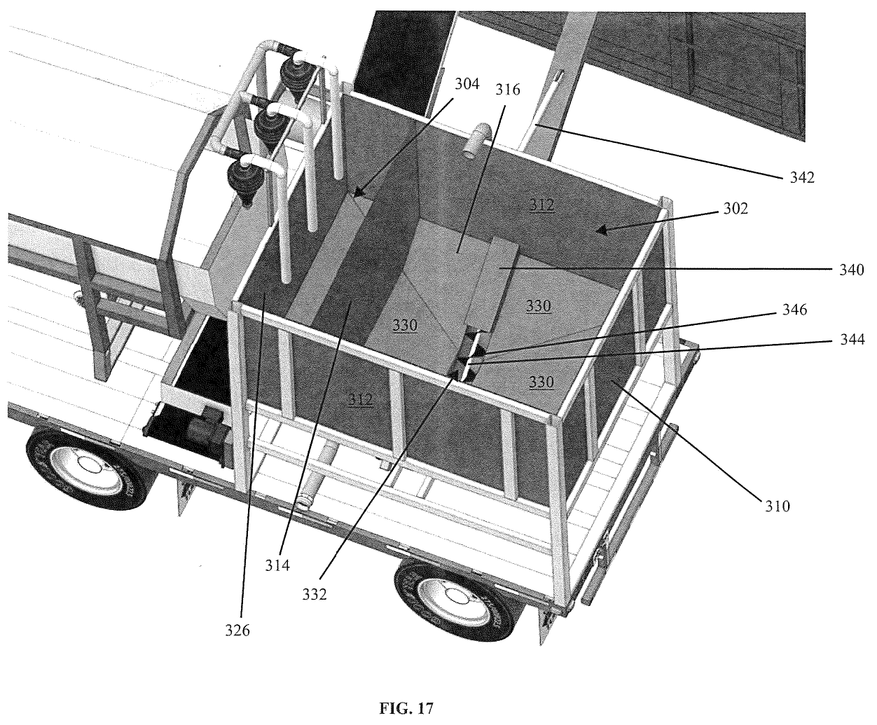

FIG. 18 is a perspective view of a roller press assembly of a dewatering trailer system, in accordance with one or more arrangements; the view showing the roller press assembly having a first conveyor assembly, a second conveyor assembly, and a roller press having a frame, an inlet, a first roller, and a second roller.

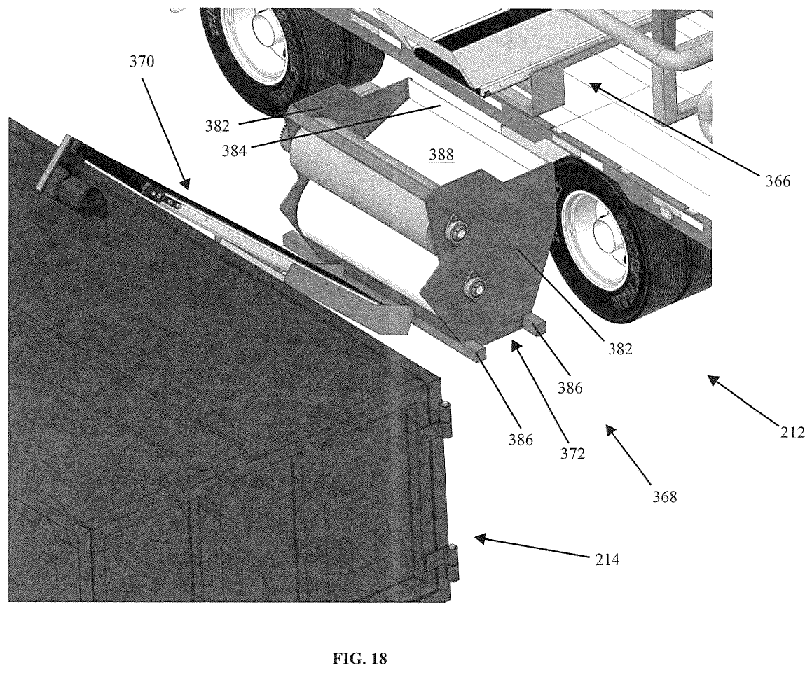

FIG. 19 is a perspective view of a roller press assembly of a dewatering trailer system, in accordance with one or more arrangements; the view showing the roller press assembly having a first conveyor assembly, a second conveyor assembly, and a roller press having a frame, an inlet, a motor, a first roller, and a second roller.

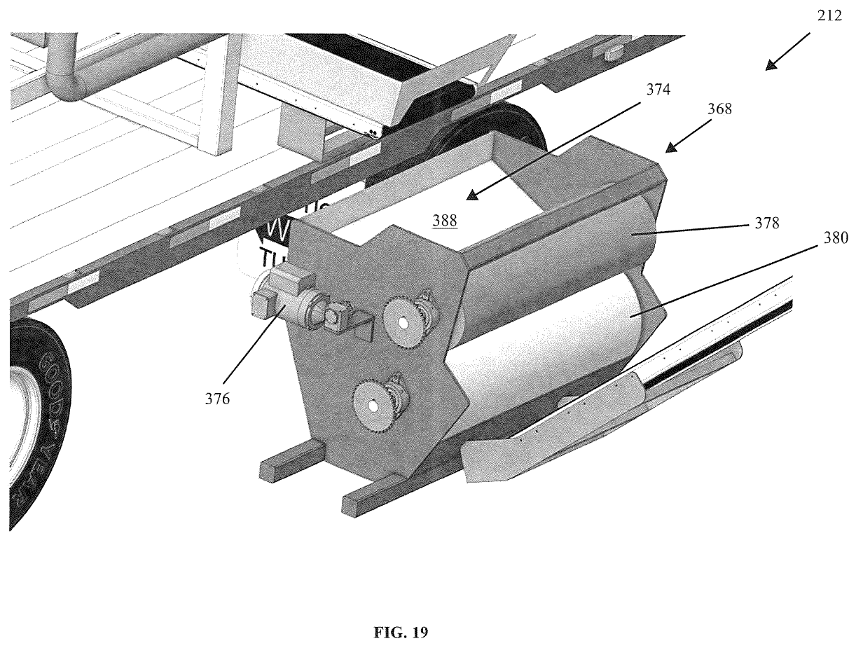

FIG. 20 is a perspective view of a dewatering trailer system, in accordance with one or more arrangements; the system having a trailer, a first holding tank, a separator, a second holding tank, and a hydrocyclone assembly.

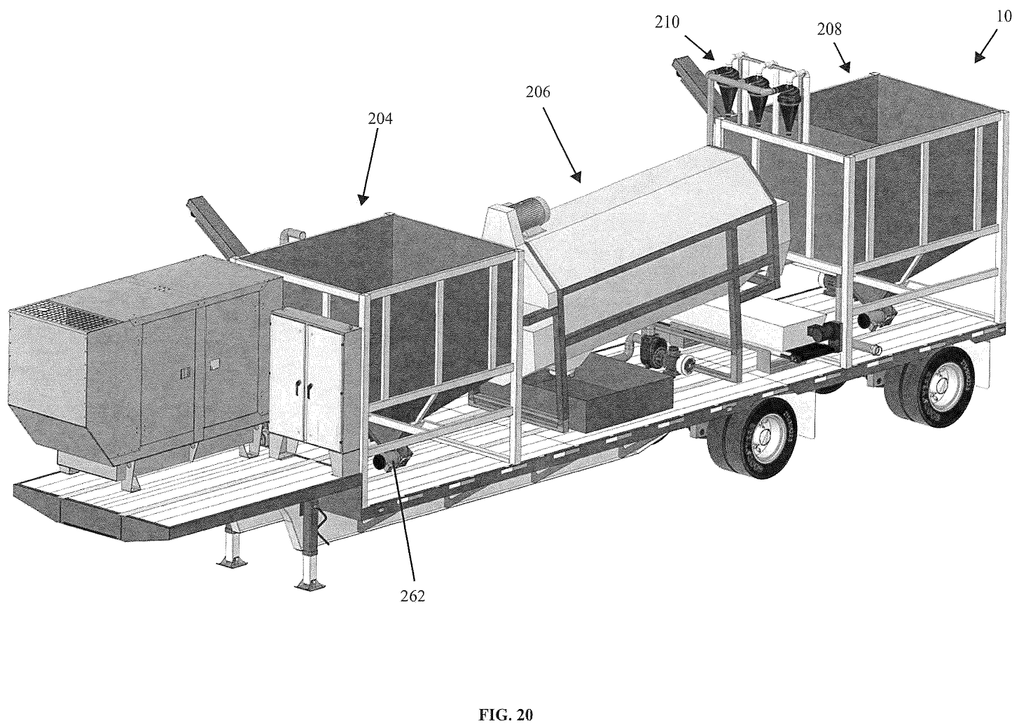

FIG. 21 is a perspective view of a separator, in accordance with one or more arrangements; the view showing the separator having a housing with opposing sidewalls, an upper wall, a rotating member, and a drain pan; the view also showing the separator having a motor.

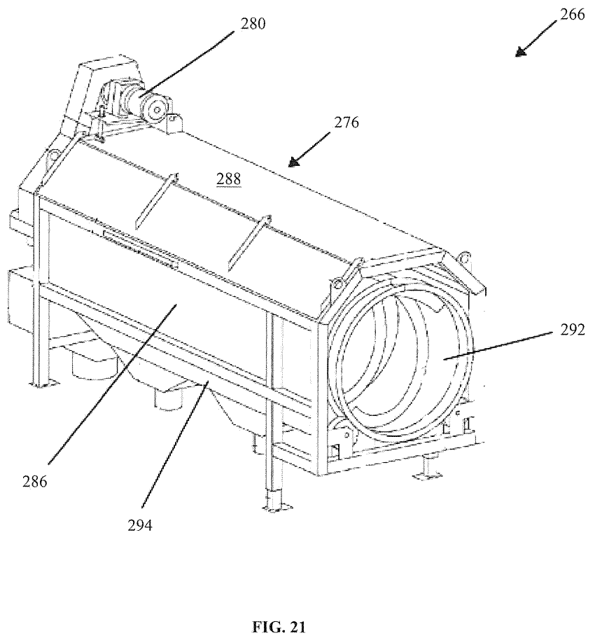

FIG. 22 is a side elevation view of a separator, in accordance with one or more arrangements; the view showing the separator having a housing with a forward end, a rearward end, an upper wall, and a lower wall, a rotating member, and a drain pan; the view also showing the separator having an inlet pipe and a drive belt.

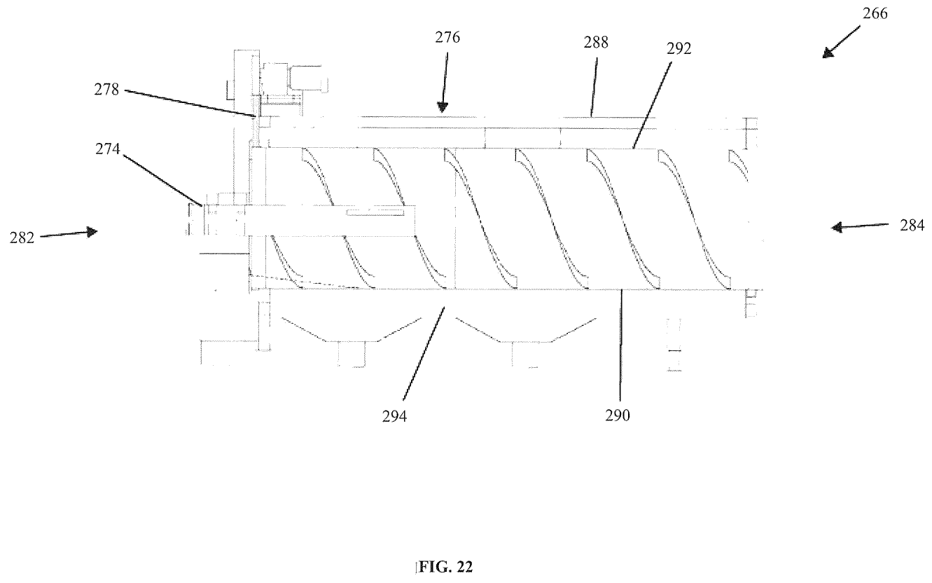

FIG. 23 is a flow diagram showing the path of material flowing through a dewatering trailer system, in accordance with one or more arrangements; the diagram showing the flow of material through the dewatering trailer system in solid lines; the diagram also showing the flow of separated solids through the dewatering trailer system in dashed lines.

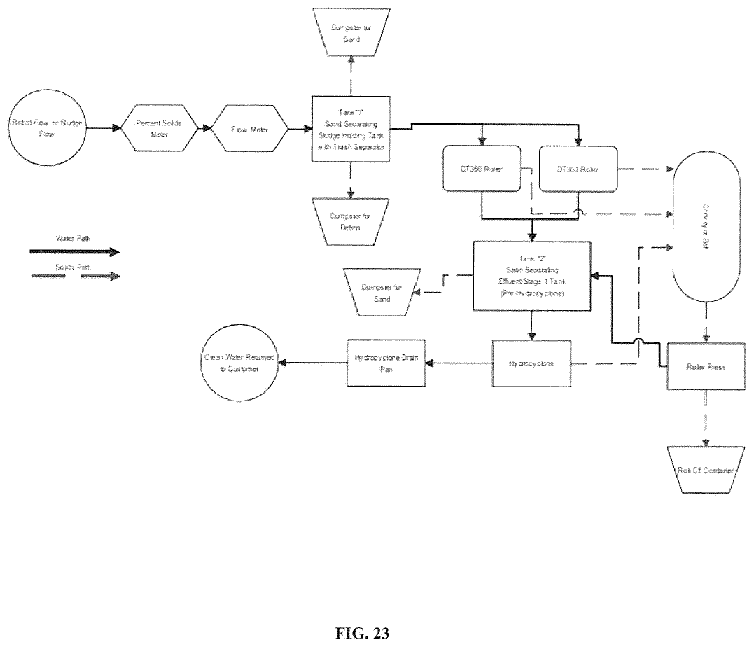

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/of” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively” or “operably”, such as when used as “operatively connected” or “operably engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of the removing solids from liquids. However, the embodiments are not so limited. It is appreciated that the embodiments may be adapted for use in other applications which may be improved by the disclosed structures, arrangements and/or methods. The system is merely shown and described as being used in the context of removing solids from liquids for ease of description and as one of countless examples.

### Dewatering Trailer System

With reference to the figures, a dewatering trailer system 10 (or simply “system 10”) is presented. System 10 is formed of any suitable size, shape, and design and is configured to move between various locations (i.e. be mobile), separate solids from liquids, and allow liquids to be returned to the tank, pond, lagoon, or other water container or supply which the material originally came from.

In one or more arrangements, system 10 is configured to separate up to 50% of total suspended solids and up to approximately 50% total dissolved solids. In one or more arrangements, as examples, system 10 is configured to separate up to 60% of total suspended solids and up to approximately 60% of total dissolved solids. In one or more arrangements, as examples, system 10 is configured to separate up to 70% of total suspended solids and up to approximately 70% of total dissolved solids. In one or more arrangements, as examples, system 10 is configured to separate up to 80% of total suspended solids and up to approximately 80% of total dissolved solids. In one or more arrangements, as examples, system 10 is configured to separate up to 90% of total suspended solids and up to approximately 90% of total dissolved solids. In one or more arrangements, as examples, system 10 is configured to separate up to 100% of total suspended solids and up to approximately 99% of total dissolved solids from liquids and return the liquids (including as low as approximately 1% total dissolved solids) back to the tank, pond, lagoon, or other water container or supply which the material originally came from.

In the arrangement shown, as one example, system 10 has a forward end 12, a rearward end 14, opposing left and right sides 16 (or simply “sides 16”), a top side 18, and a bottom side 20. In the arrangement shown, as one example, system 10 includes a trailer 22, an inlet assembly 24, a first holding tank 26, a separator assembly 28, a conveyor belt 30, a second holding tank 32, a hydrocyclone assembly 34, waste disposal containers 36, a power source 38, a pressurized air tank 40, and a control system 42 among other components as described herein. While system 10 has been primarily described according to one or more arrangements shown, as one example, any combination, design, or arrangement may be used and is hereby contemplated for use.

In one or more arrangements, system 10 is configured to be used with a robot cleaner configured to be inserted into a tank, pond, lagoon, or other water container and pump liquids, solids, and/or sludge material from the tank, pond, lagoon, or other water container. In one or more arrangements, as examples, the robot cleaner may be, by way of example and not limitation, the submersible robot cleaner presented in U.S. patent application Ser. No. 18/588,214 entitled “SUBMERSIBLE ROBOT SYSTEM” or any other type of robot cleaner configured to be submerged and pump liquid, solid, and/or sludge material. In one or more arrangements, as examples, the robot cleaner pumps the liquid, solid, and/or sludge material through a hose system which connects to the inlet assembly 24 of system 10. Additionally or alternatively, in one or more arrangements, as examples, system 10 may be used in connection with a cleaning system or box system such as those presented in U.S. patent application Ser. No. 18/460,130 entitled “CLEANING SYSTEM”, U.S. Pat. No. 11,534,045 entitled “RETROFIT BOX SYSTEM FOR CLEANING INACCESSIBLE FLOORS”, or any similar cleaning system or box system.

### Trailer 22:

In the arrangement shown, as one example, system 10 includes trailer 22. Trailer 22 is formed of any suitable size, shape, and design and are configured to allow system 10 to be transported between various locations (i.e. allows system 10 to be mobile) and also support various components and parts of system 10. In the arrangement shown, as one example, trailer 22 is a flatbed trailer configured to connect to a vehicle which pulls trailer 22, however trailer 22 may be any other type or design of trailer including, but not limited to a box trailer, a gooseneck trailer, a low-boy trailer, a tilt trailer, a transfer trailer, or any other type of trailer. In the arrangement shown, as one example, trailer 22 includes a king pin or any other hitch, receiver, or connection means (not shown) for connecting to a vehicle, a support structure 44, axles 46, wheels 48, a landing gear 50, and jack stands 52, among other components.

Support Structure 44: In the arrangement shown, as one example, trailer 22 includes a support structure 44. Support structure 44 is formed of any suitable size, shape, and design and is configured to provide a base upon which various components of system 10 may be placed. In the arrangement shown, as one example, support structure 44 is a rectangular, planar member which extends a length between a front and back end of trailer 22 and a width between left and right sides of trailer 22. In the arrangement shown, as one example, support structure 44 may be formed of a metallic material, such as steel or aluminum, or any other metallic material, alloy, or composite. Alternatively, support structure 44 may be formed of a non-metallic material such as a wooden material, a fiberglass material, a plastics material, or any other non-metallic material or composite thereof. In the arrangement shown, as one example, support structure 44 has a flat upper surface which allows various components of system 10 to rest on trailer 22. In the arrangement shown, as one example, support structure 44 is configured to operably connect to axles 46.

Axles 46: In the arrangement shown, as one example, trailer 22 includes axles 46 and wheels 48. Axles 46 are formed of any suitable size, shape, and design and are configured to operably connect to support structure 44 and wheels 48. In the arrangement shown, as one example, axles 46 are generally cylindrical, elongated members which extend a length between the left and right sides of trailer 22. In the arrangement shown, as one example, there are two axles 46, however any other number of axles 46 may be used. In the arrangement shown, as one example, wheels 48 are connected at both end of axles 46.

Wheels 48: In the arrangement shown, as one example, trailer 22 includes wheels 48. Wheels 48 are formed of any suitable size, shape, and design and are configures to support trailer 22 and allow trailer 22 to move. In the arrangement shown, as one example, wheels 48 connect to an axle 46 and rotate about the axle 46 when trailer 22 is pulled by a vehicle, thereby allowing trailer 22 to be mobile. In the arrangement shown, as one example, there are eight wheels 48, however any other number of wheels 48 may be used. In the arrangement shown, as one example, the wheels 48 arranged with two wheels 48 at or near each end of axles 46, however any other design or configuration of wheels 48 may be used on trailer 22 in order to allow trailer 22 to move. In the arrangement shown, as one example, trailer 22 is driven to a location using wheels 48 and, once at the location, the landing gear 50 of trailer 22 may be lowered and trailer 22 may be disconnected from the vehicle pulling trailer 22.

Landing Gear 50: In the arrangement shown, as one example, trailer 22 includes landing gear 50. Landing gear 50 is formed of any suitable size, shape, and design and is configured to provide support to trailer 22 and support structure 44 when trailer 22 is at a desired location and no longer needs to be mobile. In the arrangement shown, as one example, landing gear 50 is formed of a pair of jacks connected to one another, with one jack positioned at each of the left and right sides of trailer 22 and near the front end of trailer 22. In the arrangement shown, as one example, when trailer 22 is at a desired location, landing gear 50 will extend downward from support structure 44 and the jacks which make up landing gear 50 are lowered until the bottom of landing gear 50 are touching the ground. Once landing gear 50 has made contact with the ground, the vehicle may be disconnected from trailer 22 and trailer 22 is supported by wheels 48 and landing gear 50. While landing gear 50 has been shown and described herein, in one arrangement, any other design, configuration, or arrangement of landing gear 50 may be used in trailer 22 in order to support trailer 22 when trailer 22 is stationary.

Jack Stands 52: In the arrangement shown, as one example, trailer 22 includes jack stands 52. Jack stands 52 are formed of any suitable size, shape, and design and are configured to help support trailer 22 when trailer 22 is stationary. In the arrangement shown, as one example, jack stands 52 are tubular, adjustable members which are configured to adjust to a certain height and lock in place to support when trailer 22 is stationary. In the arrangement shown, as one example, when trailer 22 is at a desired location and landing gear 50 has been utilized to disconnect trailer 22 from the vehicle pulling trailer 22, jack stands 52 may be adjusted until feet of jack stands 52 are on the ground. Once jack stands 52 are stable on the ground, jack stands 52 may help support trailer 22 along with landing gear 50 and wheels 48, or landing gear 50 may then be raised and trailer 22 may be supported by jack stands 52 and wheels 48.

While trailer 22 and its components have been primarily described according to one or more arrangements shown, as one example, it will be understood by those skilled in the art that any other configuration of trailer 22 and its components may be used in order to allow system 10 to be transported between various locations (i.e. allows system 10 to be mobile) and also support various components and parts of system 10.

### Inlet Assembly 24:

In the arrangement shown, as one example, system 10 includes inlet assembly 24. Inlet assembly 24 is formed of any suitable size, shape, and design and is configured to allow materials to enter into system 10 from a pond, lagoon, or tank and flow to first holding tank 26, and also monitor the rate of flow and characteristics of materials entering system 10. In the arrangement shown, as one example, inlet assembly 24 includes a hose hookup 56, a percent solids meter 58, a flow meter 60, and a conduit 62.

In the arrangement shown, as one example, inlet assembly 24 is located near the forward end 12 of system 10 and is positioned on top of support structure 44 of trailer 22. In the arrangement shown, as one example, inlet assembly 24 is also positioned adjacent first holding tank 26. However, inlet assembly 24 may be positioned at any other location and assembled in any other configuration in order to allow materials to enter into system 10 and monitor the rate of flow and characteristic of materials entering system 10.

Hose Hookup 56: In the arrangement shown, as one example, inlet assembly 24 includes hose hookup 56. Hose hookup 56 is formed of any suitable size, shape, and design and is configured to connect to a hose and allow materials to enter system 10. In the arrangement shown, as one example, hose hookup 56 is a hose fitting or similar connection member which allows system 10 to connect to a hose or pipe and allow materials to flow from said hose or pipe into and through hose hookup 56. In the arrangement shown, as one example, hose hookup 56 is connected to percent solids meter 58 and flow meter 60.

Percent Solids Meter 58: In the arrangement shown, as one example, inlet assembly 24 includes percent solids meter 58. Percent solids meter 58 is formed of any suitable size, shape, and design and is configured to measure the percent of solids entering system 10. In the arrangement shown, as one example, percent solids meter 58 is positioned adjacent or near hose hookup 56 in order to measure the percent of solids entering system 10 near the source.

In one or more arrangements, as examples, when system 10 is used in connection with a submersible robot cleaner, the percent solids meter 58 also helps determine when to move the robot cleaner within the tank, pond, lagoon, or other water container that the robot cleaner is cleaning. That is, in one or more arrangements, as examples, a submersible cleaner and system 10 may be controlled by one user and that user can monitor the percent of solids entering system 10 via readouts from percent solids meter 58. When the submersible robot cleaner starts cleaning the tank, pond, lagoon, or other water container the readouts from percent solids meter 58 will likely be high, indicating a high number of solids are entering system 10. After a while, the readouts from percent solids meter 58 will begin to decrease, indicating that the area where the submersible robot cleaner is located is likely clean (or becoming clean) and there are not as many solids in that area that need to be removed, so the robot cleaner can be moved to a different location. In this way, the percent solids meter 58 helps determine when to move the robot cleaner within the tank, pond, lagoon, or other water container and also help a user determine when the tank, pond, lagoon, or other water container is clean enough.

Flow Meter 60: In the arrangement shown, as one example, inlet assembly 24 also includes flow meter 60. Flow meter 60 is formed of any suitable size, shape, and design and is configured to measure the rate of flow at which material is entering system 10. In the arrangement shown, as one example, flow meter 60 is positioned adjacent or near hose hookup 56 in order to measure the flow at which material is entering system 10 near the source.

In one or more arrangements, as examples, flow meter 60 and percent solids meter 58 are combined into one meter which is capable of performing the capabilities of flow meter 60 and percent solids meter 58. That is, in one or more arrangements, as examples, one meter may be both percent solids meter 58 and flow meter 60, meaning that the meter is capable of measure the percent of solids entering system 10, as well as the rate of flow at which material enters system 10. However, in one or more alternative arrangements, as examples, flow meter 60 and percent solids meter 58 may be separate meters that are otherwise operably connected within inlet assembly 24.

In one or more arrangements, as examples, when system 10 is used in connection with a submersible robot cleaner, the flow meter 60 also helps determine if there is an issue with the robot cleaner, such the cleaner not properly pumping material into system 10, or an issue with the hose connecting the robot cleaner and system 10 which is preventing material from reaching system 10. That is, in one or more arrangements, as examples, the rate of flow of material entering system 10 should be consistent with the rate at which the robot cleaner is pumping material from the tank, pond, lagoon, or other water container and this rate is already known. In one or more arrangements, as examples, because this rate is known the user operating system 10 can review the readouts from flow meter 60 to make sure the rate of flow of material entering system 10 is consistent with the rate at which the robot cleaner is pumping material. If the user determines that the readouts from flow meter 60 is indicating the rate of flow of material entering system 10 is not consistent with the rate at which the robot cleaner is pumping material, then the user can shut the robot cleaner off and inspect the robot cleaner and the hose connecting the robot cleaner to system 10 to identify and address the issue with the flow of material entering system 10.

Conduit 62: In the arrangement shown, as one example, inlet assembly 24 includes conduit 62. Conduit 62 is formed of any suitable size, shape, and design and is configured to fluidly connect hose hookup 56 of inlet assembly 24 to first holding tank 26. In the arrangement shown, as one example, conduit 62 is a generally cylindrical pipe with a hollow center which allows fluid to move through conduit 62. In the arrangement shown, as one example, conduit 62 connects at one end to percent solids meter 58 and/or flow meter 60 and at its second end to first holding tank 26.

While inlet assembly 24 and various components of inlet assembly 24 have been primarily described according to one or more arrangements shown, as one example, it will be understood by those skilled in the art that any other configuration of inlet assembly 24 and various components of inlet assembly 24 may be used in order to allow materials to enter into system 10 from a pond, lagoon, or tank and flow to first holding tank 26, and also monitor the rate of flow and characteristics of materials entering system 10.

### First Holding Tank 26:

In the arrangement shown, as one example, system 10 includes first holding tank 26. First holding tank 26 is formed of any suitable size, shape, and design and is configured to receive the flow of material entering system 10 through inlet assembly 24, decrease the rate of flow of material before it moves through other components of system 10, and remove large waste material before it moves through other components of system 10. In the arrangement shown, as one example, first holding tank 26 includes a frame 66, a front wall 68, a back wall 70, opposing sidewalls 72, a screen assembly 74, a floor 76, and an outlet pipe 78.

Frame 66: In the arrangement shown, as one example, first holding tank 26 includes frame 66. Frame 66 is formed of any suitable size, shape, and design and is configured to provide structural support to first holding tank 26. In the arrangement shown as one example, frame 66 is formed of multiple pieces that are connected or assembled to one another through welding, however any other means of connecting or assembling the multiple pieces may be used, including bolting, screwing, riveting, friction fitting, or the like. Alternatively, frame 66 may be formed of a single, unitary member that is formed in a manufacturing process such as machining, extrusion, forming, additive manufacturing, laser cutting, or the like to form a unitary and monolithic member. In the arrangement shown, as one example, frame 66 is formed primarily of a metallic material such as steel, aluminum, chromium, or any other metallic material, alloy, and/or composite thereof. Alternatively, frame 66 may be formed of a non-metallic material such as a plastic material, a fiberglass material, or any other non-metallic material and/or composite thereof.

In the arrangement shown, as one example, frame 66 includes vertical members 80 and horizontal members 82. In the arrangement shown, as one example, vertical members 80 extend vertically around the exterior of first holding tank 26. In other words, in the arrangement shown, as one example, vertical members 80 extend vertically and are positioned on the outside of front wall 68, back wall 70, and opposing sidewalls 72 to provide structural support to front wall 68, back wall 70, and opposing sidewalls 72. In the arrangement shown, as one example, horizontal members 82 extent horizontally and connect to each of the vertical members 80 at both the top and bottom ends of vertical members 80, thereby operably connecting all of the vertical members 80. In the arrangement shown, as one example, the horizontal members 82 connected to the top ends of vertical members 80 also connects to the exterior of first holding tank 26, or said another, to the outside of front wall 68, back wall 70, and opposing sidewalls 72, thereby providing structural support to front wall 68, back wall 70, and opposing sidewalls 72.

Front Wall 68: In the arrangement shown, as one example, first holding tank 26 includes front wall 68. Front wall 68 is formed of any suitable size, shape, and design and is configured to help contain material that enters first holding tank 26. In the arrangement shown, as one example, front wall 68 is a generally rectangular or square, planar member which extends a height between opposing ends and a length between opposing sides. In the arrangement shown, as one example, front wall 68 connects at one end to one of the opposing sidewall 72 and front wall 68 connects at the opposing end to the other opposing sidewall 72.

In the arrangement shown as one example, front wall 68 is formed of a single, unitary member that is formed in a manufacturing process such as machining, extrusion, forming, additive manufacturing, laser cutting, or the like to form a unitary and monolithic member. Alternatively, front wall 68 may be formed of multiple pieces that are connected or assembled to one another through bolting, screwing, welding, friction fitting, or the like. In the arrangement shown, as one example, front wall 68 is formed primarily of a metallic material such as steel, aluminum, chromium, or any other metallic material, alloy, and/or composite thereof. Alternatively, front wall 68 may be formed of a non-metallic material such as a plastic material, a fiberglass material, or any other non-metallic material and/or composite thereof.

Back Wall 70: In the arrangement shown, as one example, first holding tank 26 includes back wall 70. Back wall 70 is formed of any suitable size, shape, and design and is configured to help contain material that enters first holding tank 26 and provide a space where material can flow out of first holding tank 26. In the arrangement shown, as one example, back wall 70 is a generally rectangular or square, planar member which extends a height between opposing ends and a length between opposing sides. In the arrangement shown, as one example, back wall 70 connects at one end to one of the opposing sidewall 72 and back wall 70 connects at the opposing end to the other opposing sidewall 72.

In the arrangement shown as one example, back wall 70 is formed of a single, unitary member that is formed in a manufacturing process such as machining, extrusion, forming, additive manufacturing, laser cutting, or the like to form a unitary and monolithic member. Alternatively, back wall 70 may be formed of multiple pieces that are connected or assembled to one another through bolting, screwing, welding, friction fitting, or the like. In the arrangement shown, as one example, back wall 70 is formed primarily of a metallic material such as steel, aluminum, chromium, or any other metallic material, alloy, and/or composite thereof. Alternatively, back wall 70 may be formed of a non-metallic material such as a plastic material, a fiberglass material, or any other non-metallic material and/or composite thereof.

In the arrangement shown, as one example, back wall 70 includes an opening 84. Opening 84 is formed of any suitable size, shape, and design and is configured to connect to outlet pipe 78 and provide way for material to leave first holding tank 26. In the arrangement shown, as one example, opening 84 extends through back wall 70 and allows material to flow through back wall 70 and into outlet pipe 78.

Opposing Sidewalls 72: In the arrangement shown, as one example, first holding tank 26 includes opposing sidewalls 72. Opposing sidewalls 72 are formed of any suitable size, shape, and design and is configured to help contain material that enters first holding tank 26. In the arrangement shown, as one example, opposing sidewalls 72 are generally rectangular, planar members which extend a height between opposing ends and a length between opposing sides. In the arrangement shown, as one example, opposing sidewalls 72 connect at one end to front wall 68 and opposing sidewalls 72 at the opposing end to back wall 70.

In the arrangement shown as one example, opposing sidewalls 72 are formed of a single, unitary member that is formed in a manufacturing process such as machining, extrusion, forming, additive manufacturing, laser cutting, or the like to form a unitary and monolithic member. Alternatively, opposing sidewalls 72 may be formed of multiple pieces that are connected or assembled to one another through bolting, screwing, welding, friction fitting, or the like. In the arrangement shown, as one example, opposing sidewalls 72 are formed primarily of a metallic material such as steel, aluminum, chromium, or any other metallic material, alloy, and/or composite thereof. Alternatively, opposing sidewalls 72 may be formed of a non-metallic material such as a plastic material, a fiberglass material, or any other non-metallic material and/or composite thereof.

Screen assembly 74: In the arrangement shown, as one example, first holding tank 26 includes screen assembly 74. Screen assembly 74 is formed of any suitable size, shape, and design and is configured to remove large waste material before such large waste material can move through other components of system 10. In the arrangement shown, as one example, screen assembly 74 includes a perforated plate 86, walls 88, and a lift mechanism (not pictured).

In the arrangement shown, as one example, screen assembly 74 includes perforated plate 86. Perforated plate 86 is formed of any suitable size, shape, and design and is configured to allow liquid and smaller solid materials to travel through screen assembly 74 into first holding tank 26 while stopping large waste material from moving through screen assembly 74. In the arrangement shown, as one example, perforated plate 86 is a generally rectangular, planar member which includes holes extending through perforated plate 86. In the arrangement shown, as one example, the holes in perforated plate 86 are generally sized and shaped such that liquid and smaller solid materials may travel through perforated plate 86 and screen assembly 74 and into first holding tank 26. In the arrangement shown, as one example, the holes in perforated plate 86 are generally sized and shaped such that larger waste materials, such as wrappers, bottles, cans, and other larger pieces of garbage or waste material are prevented from passing through perforated plate 86.

In the arrangement shown, as one example, the larger waste material which is prevented from passing through perforated plate 86 is contained on perforated plate 86 by walls 88. Walls 88 are formed of any suitable size, shape, and design and are configured to provide a barrier around perforated plate 86 such that the larger waste material prevented from passing through perforated plate 86 does not pass into first holding tank 26 by being pushed off the sides of perforated plate 86.

In the arrangement shown, as one example, when enough large waste material is held on perforated plate 86 by walls 88, the lift mechanism (not shown) of screen assembly 74 may be used to dump the large waste material off of perforated plate 86 and into a dumpster or similar waste disposal container, such as waste disposal container 36. The lift mechanism of first holding tank 26 is formed of any suitable size, shape, and design and is configured to lift perforated plate 86 upward, above the tops of walls 88, and tip perforated plate 86 outward such that large waste material will fall off the edge of perforated plate 86 and to a location that is outside of first holding tank 26. At such location, a waste disposal container 36 may be placed to catch the large waste material. Then the lift mechanism of screen assembly 74 may be lowered, thereby lowering perforated plate 86 back into place between walls 88. In one or more arrangements, the lift mechanism may be any sort of hydraulic cylinder, pneumatic cylinder, a jack, or any other type of hydraulic, pneumatic, electric, or manual mechanism configured to raise perforated plate 86.

In the arrangement shown, as one example, material flows into first holding tank 26 through conduit 62 of inlet assembly 24. The end of conduit 62 which allows material to flow into first holding tank 26 is positioned above screen assembly 74. In the arrangement shown, as one example, when material leaves conduit 62 it flows through screen assembly 74 and then into first holding tank 26 and, more specifically, onto floor 76 of first holding tank 26.

Floor 76: In the arrangement shown, as one example, first holding tank 26 includes floor 76. Floor 76 is formed of any suitable size, shape, and design and is configured to help contain material that enters first holding tank 26 and direct the material towards opening 84 in back wall 70 in order to exit first holding tank 26. In the arrangement shown as one example, floor 76 is formed of multiple pieces that are connected or assembled to one another through welding, however any other means of connecting or assembling the multiple pieces may be used, including bolting, screwing, riveting, friction fitting, or the like. Alternatively, floor 76 may be formed of a single, unitary member that is formed in a manufacturing process such as machining, extrusion, forming, additive manufacturing, laser cutting, or the like to form a unitary and monolithic member. In the arrangement shown, as one example, floor 76 is formed primarily of a metallic material such as steel, aluminum, chromium, or any other metallic material, alloy, and/or composite thereof. Alternatively, floor 76 may be formed of a non-metallic material such as a plastic material, a fiberglass material, or any other non-metallic material and/or composite thereof.

In the arrangement shown, as one example, floor 76 includes a sloped portion 90 and a bottom portion 92. In the arrangement shown, as one example, the floor 76 of first holding tank 26 is configured to direct material towards opening 84. In the arrangement shown, as one example, opening 84 is positioned at or near the bottom of back wall 70 and at or near the end of back wall 70 near one of the opposing sidewalls 72. In the arrangement shown, as one example, floor 76 includes sloped portion 90 in order to direct material downward and toward the opposing sidewall 72 near opening 84. In the arrangement shown, as one example, sloped portion 90 meets bottom portion 92, which is a generally flat and planar surface that is in alignment with opening 84 such that the material that flows down and across sloped portion 90 goes to bottom portion 92 and ultimately through opening 84. In this way, floor 76 of first holding tank 26 directs the material entering first holding tank 26 towards opening 84 in back wall 70 in order to exit first holding tank 26.

Outlet Pipe 78: In the arrangement shown, as one example, first holding tank 26 includes an outlet pipe 78. Outlet pipe 78 is formed of any suitable size, shape, and design and is configured to allow material to move from first holding tank 26 to separator assembly 28. In the arrangement shown, as one example, outlet pipe 78 is a generally cylindrical, hollow pipe which extends between opposing ends. In the arrangement shown, as one example, the first end of outlet pipe 78 connects to opening 84 of back wall 70 such that material flowing through opening 84 enters outlet pipe 78. In the arrangement shown, as one example, the second end of outlet pipe 78 connects to the first pump 96 of separator assembly 28 such that material flowing through outlet pipe 78 may enter separator assembly 28.

In the arrangement shown as one example, outlet pipe 78 is formed of a single, unitary member that is formed in a manufacturing process such as machining, extrusion, forming, additive manufacturing, laser cutting, or the like to form a unitary and monolithic member. Alternatively, outlet pipe 78 may be formed of multiple pieces that are connected or assembled to one another through coupling, welding, friction fitting, or the like. In the arrangement shown, as one example, outlet pipe 78 is formed primarily of a metallic material such as steel, aluminum, chromium, or any other metallic material, alloy, and/or composite thereof. Alternatively, outlet pipe 78 may be formed of a non-metallic material such as a plastic material, a fiberglass material, or any other non-metallic material and/or composite thereof.

While first holding tank 26 and various components of first holding tank 26 have been primarily described according to one or more arrangements shown, as one example, it will be understood by those skilled in the art that any other configuration of first holding tank 26 and various components of first holding tank 26 may be used in order to receive the flow of material entering system 10 through inlet assembly 24, decrease the rate of flow of material before it moves through other components of system 10, and remove large waste material before it moves through other components of system 10.

### Separator Assembly 28:

In the arrangement shown, as one example, system 10 includes separator assembly 28. Separator assembly 28 is formed of any suitable size, shape, and design and is configured to facilitate separation of liquids from solids. In the arrangement shown, as one example, separator assembly 28 includes a first pump 96, a parallel flow assembly 98, separators 100, and conduit 102.

First Pump 96: In the arrangement shown, as one example, separator assembly 28 includes first pump 96. First pump 96 is formed of any suitable size, shape, and design and is configured to pump material flowing through outlet pipe 78 of first holding tank 26 into separators 100 of separator assembly 28. In the arrangement shown, as one example, first pump 96 is a centrifugal pump, however any other type or configuration of pump capable of pumping material into separators 100 may be used as first pump 96. In the arrangement shown, as one example, materials flowing through outlet pipe 78 enter into first pump 96. Once in first pump 96, the impellers (not shown) within first pump 96 rotate and force the material within first pump 96 outward and eventually out the top of first pump 96 and into parallel flow assembly 98.

Parallel Flow Assembly 98: In the arrangement shown, as one example, separator assembly 28 includes parallel flow assembly 98. Parallel flow assembly 98 is formed of any suitable size, shape, and design and is configured to split the flow of material from first holding tank 26 into parallel flows of material which travel to separators 100. In the arrangement shown, as one example, parallel flow assembly 98 is configured to split the flow of material from first holding tank 26 into two flows, with a first flow traveling to a first separator 100 and a second, parallel flow traveling to a second separator 100. While in the arrangement shown as one example parallel flow assembly splits the flow of material into two flows, any other number of parallel flows of material may be formed by parallel flow assembly 98, so long as the number of flows matches the number of separators 100. That is, in one or more arrangements, the number of separators 100 may be three and the number of flows created by parallel flow assembly 98 is also three. In one or more alternative arrangements, as examples, the number of separators 100 may be four or five or more, and the number of flows created by parallel flow assembly 98 will also be four or five or more, respectively, in order to match the number of separators 100. In the arrangement shown, as one example, parallel flow assembly 98 includes a fitting 104 and parallel conduits 106.

In the arrangement shown, as one example, parallel flow assembly 98 includes fitting 104. Fitting 104 is formed of any suitable size, shape, and design and is configured to connect first pump 96 to each of the parallel conduits 106 of parallel flow assembly 98. In the arrangement shown, as one example, fitting 104 is a T-fitting with a vertically extending portion that extends upward from first pump 96 and fluidly connects to a horizontally extending portion. In the arrangement shown, as one example, with fitting 104 being a T-fitting, the horizontally extending portion includes an opening at each end and is configured to connect to a parallel conduit 106 at each end. In this way, with fitting 104 being a T-fitting, fitting 104 splits the single flow of material from first pump 96 into two parallel flows of material which flow through respective parallel conduits 106 and into separators 100. In one or more alternative arrangements, fitting 104 may be formed of any other size, shape, and design in order to split the flow of material into any number of parallel flows, such as three, four, five, or more flows.

In the arrangement shown, as one example, parallel flow assembly 98 includes parallel conduits 106. Parallel conduits 106 are formed of any suitable size, shape, and design and are configured to connect parallel flow assembly 98 to separators 100. In the arrangement shown, as one example, a parallel conduit 106 connects at one end to an end of the horizontally extending portion of fitting 104 and at the other end to a separator 100, and more specifically the inlet pipe 110 of a separator 100.

Separators 100: In the arrangement shown, as one example, separator assembly 28 includes one or more separators 100. Separators 100 are formed of any suitable size, shape, and design and are configured to facilitate the separation of solids from liquids. In the arrangement shown, as one example, separators 100 may be a DT360 manure separator produced and sold by Daritech Inc. In the arrangement shown, as one example, separators 100 have 36 inch drums. In one or more arrangements, separators 100 may be a rotary screen separator such as the hybrid rotary screen separator shown and described in U.S. Patent Publication No. 2011/0198268 or the hybrid rotary screen separator shown and described in U.S. Pat. No. 10,286,340, both of which are herein incorporated by reference in their entireties. However, any other type of separator, including any type of manure separator, rotary drum separator, or any other type of separator manufactured, offered, or produced by any entity may be used and is hereby contemplated for use as separators 100.

In the arrangement shown, as one example, there are two separators 100, however any other number of separators 100 may be used including one, two, three, four, five, or more separators 100. Without limiting the foregoing, in the arrangement shown, as one example, separators 100 include an inlet pipe 110, a housing 112, a drive belt 114, and a motor 116.

In the arrangement shown, as one example, separators 100 include an inlet pipe 110. Inlet pipe 110 is formed of any suitable size, shape, and design and is configured to connect to a parallel conduit 106 of parallel flow assembly 98 and allow material to enter into separators 100. In the arrangement shown, as one example, inlet pipe 110 is a generally cylindrical, elongated tube which connects at one end to a parallel conduit 106 and has a second end which extends into housing 112 past forward end 120 and allows material to enter housing 112.

In the arrangement shown, as one example, separators 100 include housing 112. Housing 112 is formed of any suitable size, shape, and design and is configured to house the internal components of separators 100 and support additional components of separators 100. In the arrangement shown, as one example, when viewed from top side 18 of system 10, housing 112 is a generally rectangular member extending a length between a forward end 120 and a rearward end 122, and a width between opposing sidewalls 124. In the arrangement shown, as one example, when viewed from forward end 12 of system 10, housing 112 is generally octagonal in shape and extends a length between opposing sidewalls 124 and a height between upper wall 126 and lower wall 128, and when viewed from forward end 12 of system 10 housing 112 includes a generally hollow interior. In the arrangement shown, as one example, when viewed from an opposing side 16 of system 10, housing 112 is generally rectangular in shape and extends a length between forward end 120 and rearward end 122, and a height between upper wall 126 and lower wall 128.

In the arrangement shown, as one example, housing 112 includes a rotating member 130 within the hollow interior of housing 112. Rotating member 130 is formed of any suitable size, shape, and design and is configured to rotate within the hollow interior of housing 112 in order to help separate liquids from solids. In the arrangement shown, as one example, rotating member 130 is generally circular in shape and extends from at or near the forward end 120 of housing 112 to at or near the rearward end 122 of housing 112. In the arrangement shown, as one example, rotating member 130 also connects to drive belt 114 and is driven (i.e. rotated) by drive belt 114 and motor 116.

In the arrangement shown, as one example, material that enters housing 112 through inlet pipe 110, falls into rotating member 130. In the arrangement shown, as one example, rotating member 130 has perforations (not shown) which allow liquid and fine solid materials to fall through rotating member 130 and into drain pan 132. In the arrangement shown, as one example, when material falls into rotating member 130, the perforations allow liquid and fine solid materials to fall through the perforations in rotating member 130 and into drain pan 132, thereby separating liquid from solids. In the arrangement shown, as one example, the interior surface of rotating member 130 includes helical protrusions and, when rotating member 130 is rotated, the helical protrusions cause material that does not drain through the perforations to move toward the rearward end 122 of housing 112 and eventually out of housing 112 and onto conveyor belt 30.

In the arrangement shown, as one example, separators 100 include a drive belt 114 and a motor 116. Drive belt 114 is formed of any suitable size, shape, and design and is configured to connect to rotating member 130 and motor 116 and transfer the rotation of motor 116 to rotating member 130. In the arrangement shown, as one example, drive belt 114 may be any brand, material, specification, configuration, or size of drive belt known in the art. Motor 116 is formed of any suitable size, shape, and design and is configured to facilitate the rotational movement of rotating member 130. In the arrangement shown, as one example, motor 116 may be an electric motor or engine, or motor 116 may be a gas powered motor or engine, diesel powered motor or engine, solar powered motor, or any other type of motor, engine, or power source capable of facilitating rotational movement of rotating member 130.

In the arrangement shown, as one example, housing 112 includes drain pan 132. Drain pan 132 is formed of any suitable size, shape, and design and is configured to catch liquids and fine solid materials that fall through the perforations of rotating member 130 and direct the fluid to conduit 102. In the arrangement shown, as one example, drain pan 132 rests below rotating member 130 and is a generally elongated, rectangular member with an open top allowing the liquid falling through rotating member 130 to enter into drain pan 132. In the arrangement shown, as one example, the bottom or floor of drain pan 132 may be sloped in order to direct water toward and into a fluid output 134.

In the arrangement shown, as one example, drain pans 132 of housing 112 of separators 100 include fluid outputs 134. Fluid outputs 134 are formed of any suitable size, shape, and design and are configured to facilitate removal of fluid and fine solid materials from drain pan 132. In the arrangement shown, as one example, fluid outputs 134 extend downward and outward from drain pans 132 at one end and connect at its other end to second pump 136 of separator assembly 28. In the arrangement shown, as one example, each separator 100 has its own fluid output 134 and the fluid outputs 134 both meet and connect to second pump 136. In the arrangement shown, as one example, second pump 136 is formed of any suitable size, shape, and design and is configured to pump the material flowing out each of the separators 100 through fluid outputs 134 through conduit 102 and into second holding tank 32.

Conduit 102: In the arrangement shown, as one example, separator assembly 28 includes conduit 102. Conduit 102 is formed of any suitable size, shape, and design and is configured to facilitate the flow of liquids and find solids flowing out of separators 100 to second holding tank 32. In the arrangement shown, as one example, conduit 102 is a generally elongated, cylindrical tube which extends from a first end connected to second pump 136 of separator assembly 28 to second holding tank 32.

In the arrangement shown, as one example, separator assembly 28 works to separate solids from liquids. In the arrangement shown, as one example, the liquids and fine solid material flow out of separators 100, through conduit 102, and into second holding tank 32. In the arrangement shown, as one example, the coarse solids that do not fall through the perforations in rotating member 130 are forced out of the rearward end 122 of housing 112 due to the helical protrusions on the interior surface of rotating member 130. In the arrangement shown, as one example, when the coarse solids fall out of the rearward end 122 of housing 112, they fall onto conveyor belt 30 to be disposed of.

While separator assembly 28 and various components of separator assembly 28 have been primarily described according one or more arrangements shown, as one example, it will be understood by those skilled in the art that any other configuration of separator assembly 28 and various components of separator assembly 28 may be used in order to facilitate separation of liquids from solids.

### Conveyor Belt 30:

In the arrangement shown, as one example, system 10 includes conveyor belt 30. Conveyor belt 30 is formed of any suitable size, shape, and design and is configured to facilitate the disposal of material solid materials separated from liquid using system 10. In the arrangement shown, as one example, conveyor belt 30 is an incline belt conveyor, however any other type of conveyor belt may be used including, but not limited to, a flat belt conveyor, a roller bed conveyor belt, a modular belt conveyor, a cleated belt conveyor, or any other type, design, or configuration of conveyor belt.

In the arrangement shown, as one example, conveyor belt 30 is positioned such that the coarse solid materials separated by separators 100 fall onto conveyor belt 30. Additionally, conveyor belt 30 is positioned such that the fine solid materials separated by hydrocyclone 168 also fall onto conveyor belt 30. In the arrangement shown, as one example, when the solids fall onto conveyor belt 30, conveyor belt 30 operated to move the solid materials along the length of conveyor belt 30 until they reach the end of conveyor belt 30. When the solid materials reach the end of conveyor belt 30, they fall off the edge of conveyor belt 30 and into a waste disposal container 36 for disposal.

While conveyor belt 30 has been primarily described according to one or more arrangements shown, as one example, it will be understood by those skilled in the art that any other configuration of conveyor belt 30 may be used in order to facilitate the disposal of material solid materials separated from liquid using system 10.

### Second Holding Tank 32:

In the arrangement shown, as one example, system 10 includes second holding tank 32. Second holding tank 32 is formed of any suitable size, shape, and design and is configured to receive the flow of liquid and fine solid material from separator assembly 28 and decrease the rate of flow of material before it moves to hydrocyclone assembly 34. In the arrangement shown, as one example, second holding tank 32 includes a frame 140, a front wall 142, a back wall 144, opposing sidewalls 146, a floor 148, and an outlet pipe 150.

Frame 140: In the arrangement shown, as one example, second holding tank 32 includes frame 140. Frame 140 is formed of any suitable size, shape, and design and is configured to provide structural support to second holding tank 32. In the arrangement shown as one example, frame 140 is formed of multiple pieces that are connected or assembled to one another through welding, however any other means of connecting or assembling the multiple pieces may be used, including bolting, screwing, riveting, friction fitting, or the like. Alternatively, frame 140 may be formed of a single, unitary member that is formed in a manufacturing process such as machining, extrusion, forming, additive manufacturing, laser cutting, or the like to form a unitary and monolithic member. In the arrangement shown, as one example, frame 140 is formed primarily of a metallic material such as steel, aluminum, chromium, or any other metallic material, alloy, and/or composite thereof. Alternatively, frame 140 may be formed of a non-metallic material such as a plastic material, a fiberglass material, or any other non-metallic material and/or composite thereof.

In the arrangement shown, as one example, frame 140 includes vertical members 152 and horizontal members 154. In the arrangement shown, as one example, vertical members 152 extend vertically around the exterior of second holding tank 32. In other words, in the arrangement shown, as one example, vertical members 152 extend vertically and are positioned on the outside of front wall 142, back wall 144, and opposing sidewalls 146 to provide structural support to front wall 142, back wall 144, and opposing sidewalls 146. In the arrangement shown, as one example, horizontal members 154 extent horizontally and connect to each of the vertical members 152 at both the top and bottom ends of vertical members 152, thereby operably connecting all of the vertical members 152. In the arrangement shown, as one example, the horizontal members 154 connected to the top ends of vertical members 152 also connects to the exterior of second holding tank 32, or said another, to the outside of front wall 142, back wall 144, and opposing sidewalls 146, thereby providing structural support to front wall 142, back wall 144, and opposing sidewalls 146.

Front Wall 142: In the arrangement shown, as one example, second holding tank 32 includes front wall 142. Front wall 142 is formed of any suitable size, shape, and design and is configured to help contain material that enters second holding tank 32 and provide a space where material can flow out of second holding tank 32. In the arrangement shown, as one example, front wall 142 is a generally rectangular or square, planar member which extends a height between opposing ends and a length between opposing sides. In the arrangement shown, as one example, front wall 142 connects at one end to one of the opposing sidewall 146 and front wall 142 connects at the opposing end to the other opposing sidewall 146.

In the arrangement shown as one example, front wall 142 is formed of a single, unitary member that is formed in a manufacturing process such as machining, extrusion, forming, additive manufacturing, laser cutting, or the like to form a unitary and monolithic member. Alternatively, front wall 142 may be formed of multiple pieces that are connected or assembled to one another through bolting, screwing, welding, friction fitting, or the like. In the arrangement shown, as one example, front wall 142 is formed primarily of a metallic material such as steel, aluminum, chromium, or any other metallic material, alloy, and/or composite thereof. Alternatively, front wall 142 may be formed of a non-metallic material such as a plastic material, a fiberglass material, or any other non-metallic material and/or composite thereof.

In the arrangement shown, as one example, front wall 142 includes an opening 156. Opening 156 is formed of any suitable size, shape, and design and is configured to connect to outlet pipe 150 and provide way for material to leave second holding tank 32. In the arrangement shown, as one example, opening 156 extends through front wall 142 and allows material to flow through front wall 142 and into outlet pipe 150.

Back Wall 144: In the arrangement shown, as one example, second holding tank 32 includes back wall 144. Back wall 144 is formed of any suitable size, shape, and design and is configured to help contain material that enters second holding tank 32. In the arrangement shown, as one example, back wall 144 is a generally rectangular or square, planar member which extends a height between opposing ends and a length between opposing sides. In the arrangement shown, as one example, back wall 144 connects at one end to one of the opposing sidewall 146 and back wall 144 connects at the opposing end to the other opposing sidewall 146.

In the arrangement shown as one example, back wall 144 is formed of a single, unitary member that is formed in a manufacturing process such as machining, extrusion, forming, additive manufacturing, laser cutting, or the like to form a unitary and monolithic member. Alternatively, back wall 144 may be formed of multiple pieces that are connected or assembled to one another through bolting, screwing, welding, friction fitting, or the like. In the arrangement shown, as one example, back wall 144 is formed primarily of a metallic material such as steel, aluminum, chromium, or any other metallic material, alloy, and/or composite thereof. Alternatively, back wall 144 may be formed of a non-metallic material such as a plastic material, a fiberglass material, or any other non-metallic material and/or composite thereof.

Opposing Sidewalls 146: In the arrangement shown, as one example, second holding tank 32 includes opposing sidewalls 146. Opposing sidewalls 146 are formed of any suitable size, shape, and design and is configured to help contain material that enters second holding tank 32. In the arrangement shown, as one example, opposing sidewalls 146 are generally rectangular, planar members which extend a height between opposing ends and a length between opposing sides. In the arrangement shown, as one example, opposing sidewalls 146 connect at one end to front wall 142 and opposing sidewalls 146 at the opposing end to back wall 144.

In the arrangement shown as one example, opposing sidewalls 146 are formed of a single, unitary member that is formed in a manufacturing process such as machining, extrusion, forming, additive manufacturing, laser cutting, or the like to form a unitary and monolithic member. Alternatively, opposing sidewalls 146 may be formed of multiple pieces that are connected or assembled to one another through bolting, screwing, welding, friction fitting, or the like. In the arrangement shown, as one example, opposing sidewalls 146 are formed primarily of a metallic material such as steel, aluminum, chromium, or any other metallic material, alloy, and/or composite thereof. Alternatively, opposing sidewalls 146 may be formed of a non-metallic material such as a plastic material, a fiberglass material, or any other non-metallic material and/or composite thereof.

Floor 148: In the arrangement shown, as one example, second holding tank 32 includes floor 148. Floor 148 is formed of any suitable size, shape, and design and is configured to help contain material that enters second holding tank 32 and direct the material towards opening 156 in front wall 142 in order to exit second holding tank 32. In the arrangement shown as one example, floor 148 is formed of multiple pieces that are connected or assembled to one another through welding, however any other means of connecting or assembling the multiple pieces may be used, including bolting, screwing, riveting, friction fitting, or the like. Alternatively, floor 148 may be formed of a single, unitary member that is formed in a manufacturing process such as machining, extrusion, forming, additive manufacturing, laser cutting, or the like to form a unitary and monolithic member. In the arrangement shown, as one example, floor 148 is formed primarily of a metallic material such as steel, aluminum, chromium, or any other metallic material, alloy, and/or composite thereof. Alternatively, floor 148 may be formed of a non-metallic material such as a plastic material, a fiberglass material, or any other non-metallic material and/or composite thereof.

In the arrangement shown, as one example, floor 148 includes sloped portions 158 and a bottom portion 160. In the arrangement shown, as one example, the floor 148 of second holding tank 32 is configured to direct material towards opening 156. In the arrangement shown, as one example, opening 156 is positioned at or near the bottom of front wall 142 and at or near the middle of front wall 142. In the arrangement shown, as one example, floor 148 includes sloped portions 158 near each of the opposing sidewalls 146 which slope downward and inward toward the middle of second holding tank 32 in order to direct material downward and toward opening 156 positioned at or near the middle of front wall 142. In the arrangement shown, as one example, sloped portions 158 meet bottom portion 160, which is a generally flat and planar surface that is in alignment with opening 156 such that the material that flows down and across sloped portions 158 goes to bottom portion 160 and ultimately through opening 156. In this way, floor 148 of second holding tank 32 directs the material entering second holding tank 32 towards opening 156 in front wall 142 in order to exit second holding tank 32.

Outlet Pipe 150: In the arrangement shown, as one example, second holding tank 32 includes an outlet pipe 150. Outlet pipe 150 is formed of any suitable size, shape, and design and is configured to allow material to move from second holding tank 32 to hydrocyclone assembly 34. In the arrangement shown, as one example, outlet pipe 150 is a generally cylindrical, hollow pipe which extends between opposing ends. In the arrangement shown, as one example, the first end of outlet pipe 150 connects to opening 156 of front wall 142 such that material flowing through opening 156 enters outlet pipe 150. In the arrangement shown, as one example, the second end of outlet pipe 150 connects to the first pump 164 of hydrocyclone assembly 34 such that material flowing through outlet pipe 150 may enter hydrocyclone assembly 34.

In the arrangement shown as one example, outlet pipe 150 is formed of a single, unitary member that is formed in a manufacturing process such as machining, extrusion, forming, additive manufacturing, laser cutting, or the like to form a unitary and monolithic member. Alternatively, outlet pipe 150 may be formed of multiple pieces that are connected or assembled to one another through coupling, welding, friction fitting, or the like. In the arrangement shown, as one example, outlet pipe 150 is formed primarily of a metallic material such as steel, aluminum, chromium, or any other metallic material, alloy, and/or composite thereof. Alternatively, outlet pipe 150 may be formed of a non-metallic material such as a plastic material, a fiberglass material, or any other non-metallic material and/or composite thereof.

While second holding tank 32 and various components of second holding tank 32 have been primarily described according to one or more arrangements shown, as one example, it will be understood by those skilled in the art that any other configuration of second holding tank 32 and various components of second holding tank 32 may be used in order to receive the flow of liquid and fine solid material from separator assembly 28 and decrease the rate of flow of material before it moves to hydrocyclone assembly 34.

### Hydrocyclone Assembly 34:

In the arrangement shown, as one example, system 10 includes hydrocyclone assembly 34. Hydrocyclone assembly 34 is formed of any suitable size, shape, and design and is configured to separate fine solid materials from liquid. More specifically, hydrocyclone assembly 34 is configured to separate fine solids from liquid. In the arrangement shown, as one example, hydrocyclone assembly 34 includes a first pump 164, an inlet pipe 166, a hydrocyclone 168, an outlet pipe 170, and a drain pan 172.

First Pump 164: In the arrangement shown, as one example, hydrocyclone assembly 34 includes first pump 164. First pump 164 is formed of any suitable size, shape, and design and is configured to pump material flowing through outlet pipe 150 of second holding tank 32 into hydrocyclone 168 of hydrocyclone assembly 34. In the arrangement shown, as one example, first pump 164 is a centrifugal pump, however any other type or configuration of pump capable of pumping material into hydrocyclone 168 may be used as first pump 164. In the arrangement shown, as one example, materials flowing through outlet pipe 150 enter into first pump 164. Once in first pump 164, the impellers (not shown) within first pump 164 rotate and force the material within first pump 164 outward and eventually out the top of first pump 164 and into inlet pipe 166.

Inlet Pipe 166: In the arrangement shown, as one example, hydrocyclone assembly 34 includes inlet pipe 166. Inlet pipe 166 is formed of any suitable size, shape, and design and is configured to delivery fluid and fine solids material to hydrocyclone 168. In the arrangement shown, as one example, inlet pipe 166 is a generally cylindrical pipe which extends between opposing ends. In the arrangement shown, as one example, the first end of inlet pipe 166 connects to first pump 164 such that material pumped out of first pump 164 enters inlet pipe 166. In the arrangement shown, as one example, the second end of inlet pipe 166 connects to hydrocyclone 168 such that material flowing through inlet pipe 166 enters hydrocyclone 168.

In the arrangement shown as one example, inlet pipe 166 is formed of a single, unitary member that is formed in a manufacturing process such as machining, extrusion, forming, additive manufacturing, laser cutting, or the like to form a unitary and monolithic member. Alternatively, inlet pipe 166 may be formed of multiple pieces that are connected or assembled to one another through coupling, welding, friction fitting, or the like. In the arrangement shown, as one example, inlet pipe 166 is formed primarily of a metallic material such as steel, aluminum, chromium, or any other metallic material, alloy, and/or composite thereof. Alternatively, inlet pipe 166 may be formed of a non-metallic material such as a plastic material, a fiberglass material, or any other non-metallic material and/or composite thereof.

Hydrocyclone 168: In the arrangement shown, as one example, hydrocyclone assembly 34 includes hydrocyclone 168. Hydrocyclone 168 is formed of any suitable size, shape, and design and is configured to separate solids from liquids. More specifically, in the arrangement shown as one example, hydrocyclone 168 is configured to remove fine solid material from the liquid that exits separators 100. In the arrangement shown, as one example, hydrocyclone 168 is a McLanahan® Hydrocyclone, however any other hydrocyclone, cyclonic separator, or other type of separator may be used and is hereby contemplated for use as hydrocyclone 168 in order to remove fine solid material that exits separators 100 from the liquid that exits separators 100. In the arrangement shown, as one example, hydrocyclone 168 includes a feed box 176, a cone 178, a spigot 180, and a regulator 182.

In the arrangement shown, as one example, hydrocyclone 168 includes feed box 176. Feed box 176 is formed of any suitable size, shape, and design and is configured to receive material from inlet pipe 166 and connect to cone 178. In the arrangement shown, as one example, feed box 176 is positioned near the upper side of hydrocyclone 168 and includes an opening which is configured to connect to inlet pipe 166 in order to allow material to flow into hydrocyclone 168. In the arrangement shown, as one example, feed box 176 is a generally cylindrical member which connects to the top of cone 178 and includes a hollow interior which aligns with the hollow interior of cone 178. In the arrangement shown, as one example, the material entering feed box 176 travels in a centrifugal manner down feed box 176 and into cone 178.

In the arrangement shown, as one example, hydrocyclone 168 includes cone 178. Cone 178 is formed of any suitable size, shape, and design and is configured to help increase the speed of centrifugal rotation of materials in hydrocyclone 168. In the arrangement shown, as one example, when viewed from forward end 12, rearward end 14, or a side 16, cone 178 is generally in the shape of an inverted triangle, with an upper end that is generally wider and a lower end which is narrow and nearly forms a point. In the arrangement shown, as one example, when viewed from top side 18 or bottom side 20 of system 10, cone 178 is generally circular and has a hollow interior. In the arrangement shown, as one example, the material entering through feed box 176 falls into cone 178 while still moving in a centrifugal manner.

In the arrangement shown, as one example, hydrocyclone 168 includes a spigot 180 and regulator 182. Spigot 180 is formed of any suitable size, shape, and design and is configured to allow coarse material to exit out the bottom of hydrocyclone 168. In the arrangement shown, as one example, spigot 180 is simply an opening in the bottom of cone 178. Regulator 182 is formed of any suitable size, shape, and design and is configured to group together the coarse materials at spigot 180 and allow the coarse solid materials to fall only when the solid materials have a specific size or volume. In the arrangement shown, as one example, the solid materials that exit hydrocyclone 168 through spigot 180 must fall a ways before it reaches conveyor belt 30. In the arrangement shown, as one example, regulator 182 prevents the solid materials from falling out of spigot 180 under there is a sufficiently sized grouping of solid materials that will fall to conveyor belt 30 without being broken up and/or blown away by wind.

In the arrangement shown, as one example, the material enters the feed box 176 of hydrocyclone 168 with a predetermined pressure and in a centrifugal manner. That is, in the arrangement shown, as one example, this means the material entering hydrocyclone 168 tends to be forced toward the walls of feed box 176 and cone 178 and the predetermined pressure at which the material enters feed box 176 determines how strong the centrifugal force that acts on the material entering into feed box 176. In the arrangement shown, as one example, the heavier materials are generally forced further outward to the walls of feed box 176 and cone 178 and the liquids and extremely fine solid materials generally stay suspended toward the middle of feed box 176 and cone 178. As the heavier materials drops lower into cone 178, the shape of cone 178 forces the rotation of the heavier material to speed up, which creates a vortex. In the arrangement shown, as one example, the vortex formed causes the liquids and extremely fine solid materials suspended toward the middle of feed box 176 and cone 178 to travel upwards and eventually out of hydrocyclone 168 through outlet pipe 170.

Outlet Pipe 170: In the arrangement shown, as one example, hydrocyclone assembly 34 includes outlet pipe 170. Outlet pipe 170 is formed of any suitable size, shape, and design and is configured to allow liquids and extremely fine solid materials to exit hydrocyclone 168 and travel to drain pan 172. In the arrangement shown, as one example, a first end of outlet pipe 170 connects to the top of feed box 176, and more specifically an opening in the top of feed box 176 such that liquid and extremely fine solid materials forced out of hydrocyclone 168 enters outlet pipe 170. In the arrangement shown, as one example, the second end of outlet pipe 170 rests directly above drain pan 172 and material flowing through outlet pipe 170 falls into drain pan 172.

In the arrangement shown as one example, outlet pipe 170 is formed of a single, unitary member that is formed in a manufacturing process such as machining, extrusion, forming, additive manufacturing, laser cutting, or the like to form a unitary and monolithic member. Alternatively, outlet pipe 170 may be formed of multiple pieces that are connected or assembled to one another through coupling, welding, friction fitting, or the like. In the arrangement shown, as one example, outlet pipe 170 is formed primarily of a metallic material such as steel, aluminum, chromium, or any other metallic material, alloy, and/or composite thereof. Alternatively, outlet pipe 170 may be formed of a non-metallic material such as a plastic material, a fiberglass material, or any other non-metallic material and/or composite thereof.

Drain Pan 172: In the arrangement shown, as one example, hydrocyclone assembly 34 includes drain pan 172. Drain pan 172 is formed of any suitable size, shape, and design and is configured to collect the liquid (including less than 1% total dissolved solids) which exit hydrocyclone 168 and allow such liquid to be returned to the tank, lagoon, pond, or similar liquid container from which the material was originally pumped. In the arrangement shown, as one example, drain pan 172 is a generally rectangular tank with an open top side and enclosed sides, ends, and floor. In the arrangement shown, as one example, drain pan 172 holds the liquid that exists hydrocyclone 168, and includes an outlet 184 and a pump 186.

In the arrangement shown, as one example, drain pan 172 may be formed of a single, unitary member that is formed in a manufacturing process such as machining, extrusion, forming, additive manufacturing, laser cutting, or the like to form a unitary and monolithic member. Alternatively, drain pan 172 may be formed of multiple pieces that are connected or assembled to one another through coupling, welding, friction fitting, or the like. In the arrangement shown, as one example, drain pan 172 is formed primarily of a metallic material such as steel, aluminum, chromium, or any other metallic material, alloy, and/or composite thereof. Alternatively, drain pan 172 may be formed of a non-metallic material such as a plastic material, a fiberglass material, or any other non-metallic material and/or composite thereof.

In the arrangement shown, as one example, drain pan 172 includes outlet 184. Outlet 184 is formed of any suitable size, shape, and design and is configured to allow the liquid held within drain pan 172 to be pumped out of drain pan 172 and back to the tank, lagoon, pond, or similar liquid container from which the material was originally pumped. In the arrangement shown, as one example, outlet 184 is a generally cylindrical pipe which connects at its first end to an opening in drain pan 172 and connects at its second end to pump 186 of drain pan 172.

Pump 186 is formed of any suitable size, shape, and design and is configured to pump the liquid from drain pan 172 back to the tank, lagoon, pond, or similar liquid container from which the material was originally pumped. In the arrangement shown, as one example, pump 186 is a centrifugal pump, however any other type or configuration of pump may be used as pump 186. In the arrangement shown, as one example, materials flowing through outlet 184 enter into pump 186. Once in pump 186, the impellers (not shown) within pump 186 rotate and force the material within pump 186 outward and eventually out of pump 186 and into a hose or other pipe which goes back to the tank, lagoon, pond, or similar liquid container from which the material was originally pumped.

While hydrocyclone assembly 34 and various components of hydrocyclone assembly 34 have been primarily described according to one or more arrangements shown, as one example, it will be understood by those skilled in the art that any other configuration of hydrocyclone assembly 34 and various components of hydrocyclone assembly 34 may be used in order to separate fine solid materials from liquid.

### Waste Disposal Containers 36:

In the arrangement shown, as one example, system 10 includes waste disposal containers 36. Waste disposal containers 36 are formed of any suitable size, shape, and design and are configured to facilitate disposal of the solid materials separated from liquid using system 10. In the arrangement shown, as one example, waste disposal containers 36 are roll off containers, however in various other arrangements waste disposal containers 36 may be dumpsters or any other type of container configured to collect and facilitate disposal of waste material. In the arrangement shown, as one example, there are two waste disposal containers 36, however any other number of waste disposal containers 36 may be used including, one, two, three, four, five, or more waste disposal containers 36.

While disposal containers 36 have been primarily described according to one or more arrangements shown, as one example, it will be understood by those skilled in the art that any other configuration of disposal containers 36 may be used in order to facilitate disposal of the solid materials separated from liquid using system 10.

### Power Source 38:

In the arrangement shown, as one example, system 10 includes a power source 38. Power source 38 is formed of any suitable size, shape, and design and is configured to provide power to system 10 and various components of system 10 including separators 100 (and more specifically, the motor 116 of separators 100. In the arrangement shown, as one example, power source 38 is a gas powered generator, however any other type of generator or power source may be used as power source 38 including, but not limited to, a diesel powered generator, a solar powered generator or engine, a gas powered engine, a diesel powered engine, or any other source of power.

### Pressurized Air Tank 40:

In the arrangement shown, as one example, system 10 includes a pressurized air tank 40. Pressurized air tank 40 is formed of any suitable size, shape, and design and is configured to facilitate cleaning out of the various pipes and conduits of system 10. In the arrangement shown, as one example, pressurized air tank 40 is configured to connect to inlet assembly 24 and force air through the various pipes and conduits within system 10 in order to clean any materials (solid and/or liquid) out of the various pipes of system 10.

### Control System 42:

In the arrangement shown, as one example, system 10 may also include a control system 42. Control system 42 is formed of any suitable size, shape, and design and is configured to facilitate control of system 10 and its various components. In the arrangement shown, as one example, control system 42 may include sensors that monitor the water levels in first holding tank 26, second holding tank 32, and/or drain pan 172 of hydrocyclone assembly 34. In the arrangement shown, as one example, if a sensor on first holding tank 26, second holding tank 32, and/or drain pan 172 senses that the tank or pan is full the sensor will send a signal to control system 42. At this point, the user may manually shut off the robot cleaner so no more material enters system 10 and causes a tank to overflow, or control system 42 may receive the signal from the sensor and, through circuitry and instructions programmed into control system 42, control system 42 may automatically shut off the robot cleaner.

In the arrangement shown, as one example, control system 42 may be used in order to control the various pumps and view readouts from the various monitors in system 10. That is, in the arrangement shown, as one example, control system 42 may be used in order to control the output characteristics (rate of flow, volume, pressure, etc.) of first pump 96 of separator assembly 28, second pump 136 of separator assembly 28, first pump 164 of hydrocyclone assembly 34, and pump 186 of drain pan 172, and control system 42 may control each of these pumps independently of the other pumps. Additionally or alternatively, in the arrangement shown, as one example, control system 42 may be used in order to monitor the readouts from percent solids meter 58 and flow meter 60 in order to determine if there are any malfunctions in the robot cleaner or the hose or hose system which is pumping materials to system 10.

### In Operation:

In one or more arrangements, as examples, system 10 may be used to separate liquids from solids. In one or more arrangements, as examples, solids, liquids, and sludge suctions off the floor of a tank, lagoon, pond, or similar liquid container using a robot cleaner. In one or more arrangements, as examples, the robot cleaner is connected to system 10 through a hose or hose assembly. In the arrangement shown, as one example, the hose or hose assembly connects to inlet assembly 24. In the arrangement shown, as one example, solid, liquid, and sludge material flows into inlet assembly 24 through hose hookup 56 and the rate of flow and percent of solids flowing into inlet assembly 24 are measured using flow meter 60 and percent solids meter 58, respectively. In the arrangement shown, as one example, after the materials flow through percent solids meter 58 and flow meter 60, the material flows through conduit 62 and into first holding tank 26.

In the arrangement shown, as one example, material flowing into first holding tank 26 first goes through screen assembly 74 in order to remove large waste materials. In the arrangement shown, as one example, the material leaves conduit 62 and liquid and most waste materials flow through perforated plate 86 of screen assembly 74 while large waste materials are stopped from moving through perforated plate 86. Once there is a significant amount of large waste material on top of the perforated plate 86, the lift mechanism (not pictured) of screen assembly 74 may be utilized to lift perforated plate 86 upward and tilt it outward such that the large waste material is dumped off the edge of perforated plate 86 and into a waste disposal container 36.

In the arrangement shown, as one example, the liquid and other solid material that flows through perforated plate 86 enters first holding tank 26 and moves down the sloped portion 90 of floor 76 to the bottom portion 92 of floor 76. After the liquid and solid material makes it to bottom portion 92, it then flows out of opening 84 in back wall 70, through outlet pipe 78, and to first pump 96 of separator assembly 28. Once the fluid and solid materials reach first pump 96 of separator assembly 28, first pump 96 pumps the liquid and solid material up through parallel flow assembly 98, where the flow is split into parallel flows by fitting 104 and parallel conduits 106. In the arrangement shown, as one example, the liquid and solid materials then flow into separators 100.

In the arrangement shown, as one example, liquid and solid materials enter separators 100 through inlet pipe 110, and inlet pipe 110 directs the material into the housing 112 of separator 100, and more specifically onto rotating member 130. When the material is in the housing 112 of separator 100, the motor 116 of separator 100 begins operation, which causes the drive belt 114 of separator 100 to rotate along with motor 116. Drive belt 114 is operably connected to and partially wrapped around a portion of rotating member 130 of housing 112 of separator 100. In the arrangement shown, as one example, the rotation of drive belt 114 causes rotating member 130 to rotate as well. In the arrangement shown, as one example, as the material falls into rotating member 130, liquid and fine solid materials fall through the perforations of rotating member 130 and into drain pan 132.

In the arrangement shown, as one example, as rotating member 130 rotates, the coarse waste material which is prevented from falling into drain pan 132 moves toward the rearward end 122 of housing 112 by the helical protrusions on the interior surface of rotating member 130. In the arrangement shown, as one example, when the coarse waste material reaches rearward end 122 of housing 112, the course waste material drops off the edge of housing 112 and onto conveyor belt 30.

In the arrangement shown, as one example, the liquid and fine solids material that falls into drain pan 132 flows out of drain pan 132 through fluid output 134 and reaches second pump 136 of separator assembly 28. In the arrangement shown, as one example, there are two separators 100 operating in parallel with one another and the liquid and fine solids material flowing through both fluid outputs 134 meet and combine with one another in second pump 136. In the arrangement shown, as one example, second pump 136 then pumps the combined flow of liquid and fine solids material into and through conduit 102 of separator assembly 28, which drains into second holding tank 32.

In the arrangement shown, as one example, the fluids and fine solids material that flows through conduit 102 flows into second holding tank 32. In the arrangement shown, as one example, the second end of conduit 102 is positioned near the top end of second holding tank 32 and the fluids and fine solids material falls out of the second end of conduit 102 and into second holding tank 32. In the arrangement shown, as one example, when the liquids and fine solids material are in second holding tank 32, the sloped portions 158 of the floor 148 of second holding tank 32 operate to force the liquid and fine solids material to settle down to the bottom portion 160 of floor 148 and eventually out through opening 156 in front wall 142 of second holding tank 32.

In the arrangement shown, as one example, the liquid and fine solids material that exit through the opening 156 in front wall 142 of second holding tank 32 enter into the outlet pipe 150 of second holding tank 32 and flow to the first pump 164 of hydrocyclone assembly 34. In the arrangement shown, as one example, the first pump 164 of hydrocyclone assembly 34 pumps the liquid and fine solids material up into inlet pipe 166 of hydrocyclone assembly 34. In the arrangement shown, as one example, inlet pipe 166 connects to the feed box 176 of hydrocyclone 168 and the liquid and fine solids material flowing through inlet pipe 166 enter into hydrocyclone 168 through the feed box 176 in order for the fine solids material (or the majority of fine solids material) to be separated from the liquid.

In the arrangement shown, as one example, first pump 164 is configured to pump the liquid and fine solids material at a certain speed and pressure such that the liquid and fine solids material enter into hydrocyclone 168 at a predetermined rate, volume, and/or pressure. In the arrangement shown, as one example, the rate, volume, and/or pressure at which the liquid and fine solids material enter into hydrocyclone 168 determine the size (dimension and/or density) of material that is separated from the liquid using hydrocyclone 168. In the arrangement shown, as one example, when the liquid and fine solids material enter feed box 176 they begin to move down feed box 176 and into cone 178 in a centrifugal motion which causes the solid materials to be forced outward. As the solid materials are forced outward, the liquids and extremely fine solid materials remain toward the middle of feed box 176 and/or cone 178.

In the arrangement shown, as one example, as the solid materials continue to move down through cone 178 in a centrifugal motion, the speed at which the solid materials move downward and rotate is increased. In the arrangement shown, as one example, this increase in speed of downward movement and rotation causes a vortex to form in hydrocyclone 168. In the arrangement shown, as one example, the vortex formed causes the liquids and extremely fine solid materials suspended toward the middle of feed box 176 and cone 178 to travel upwards and eventually out of hydrocyclone 168 through outlet pipe 170. In the arrangement shown, as one example, the solids materials which are not force up and out of hydrocyclone 168 continue to move downward until they reach spigot 180. In the arrangement shown, as one example, once the solid materials reach spigot 180, regulator 182 temporarily blocks the solid materials from falling out of spigot 180 until a sufficient amount of solid materials is at spigot 180, at which point the regulator 182 gives way and allows the solids material to fall out of hydrocyclone 168 and onto conveyor belt 30.

In the arrangement shown, as one example, the liquid and extremely fine solids material that are pulled out of hydrocyclone 168 through outlet pipe 170 drain into drain pan 172 of hydrocyclone assembly 34. In the arrangement shown, as one example, the liquid and extremely fine solids material rest in drain pan 172 until they are pumped out of drain pan 172 through 184 by pump 186 of drain pan 172. In the arrangement shown, as one example, a hose, hose system, or other pipe or conduit may be connected to pump 186 of drain pan 172 and said hose, hose system, or other pipe or conduit may lead back to the tank, lagoon, pond, or similar liquid container from which the material was originally pumped out of. In this way, system 10 operates to separate solids from liquids and return liquids (with less than 1% total dissolved solids back to the tank, lagoon, pond, or similar liquid container.

In the arrangement shown, as one example, the solid waste material separated from the liquid using separators 100 and hydrocyclone 168 fall onto conveyor belt 30 as described herein. In the arrangement shown, as one example, conveyor belt 30 operates to move the solid waste material up and away from system 10 and once the solid waste material reaches the end of conveyor belt 30, the solid waste material falls off the edge of conveyor belt 30 and into a waste disposal container 36. In the arrangement shown, as one example, the waste disposal container 36 may be removed from the site where system 10 is operating and the solid waste material may be properly disposed of or repurposed and used for other operations.

### Additional Attachments:

In one or more arrangements, as examples, system 10 may also include various other components such as driers configured to dry the solid waste materials separated by separators 100 and hydrocyclone 168. Additionally or alternatively, in one or more arrangements, system 10 may include more separators and various other types of separators, depending on the specifications of the job needed to be completed. It will be understood by those of skill in the art that various other types of separators, driers, and material processing equipment may be attached to and used in system 10 and such additional components are hereby contemplated for use with system 10.

### Alternative Arrangement:

An alternative arrangement of system 10 is presented herein. In the alternative arrangement shown, as one example, system 10 has a trailer 200, an inlet assembly 202, a first holding tank 204, a separator assembly 206, a second holding tank 208, a hydrocyclone assembly 210, a roller press assembly 212, waste disposal containers 214, a power source 216, and a control system 218, among other components described herein. While this alternative arrangement of system 10 has been described according to the alternative arrangement shown, as one example, any other combination or arrangement may be used and is hereby contemplated for use in system 10.

### Trailer 200:

In the arrangement shown, as one example, system 10 includes trailer 200. Trailer 200 is formed of any suitable size, shape, and design and are configured to allow system 10 to be transported between various locations (i.e. allows system 10 to be mobile) and also support various components and parts of system 10. In the arrangement shown, as one example, trailer 200 is a drop deck trailer, a low-boy trailer, a step deck trailer, or any other trailer which has a forward end that is higher than the mid and real portions of the trailer. In the arrangement shown, as one example, trailer 200 is configured to connect to a vehicle which pulls trailer 200. In various alternative arrangements, as examples, trailer 200 may be any other type or design of trailer including, but not limited to a box trailer, a gooseneck trailer, a flatbed trailer, a tilt trailer, a transfer trailer, or any other type of trailer. In the arrangement shown, as one example, trailer 200 includes a king pin or any other hitch, receiver, or connection means (not shown) for connecting to a vehicle, a support structure 44, axles 46, wheels 48, and a landing gear 50, as have each been previously described herein, among other components as have been previously described herein.

While trailer 200 and its components have been primarily described according to one or more arrangements shown, as one example, it will be understood by those skilled in the art that any other configuration of trailer 200 and its components may be used in order to allow system 10 to be transported between various locations (i.e. allows system 10 to be mobile) and also support various components and parts of system 10.

### Inlet Assembly 202:

In the arrangement shown, as one example, system 10 includes inlet assembly 202. Inlet assembly 202 is formed of any suitable size, shape, and design and is configured to allow materials to enter into system 10 from a pond, lagoon, or tank and flow to first holding tank 204, and also monitor the rate of flow and characteristics of materials entering system 10. In the arrangement shown, as one example, inlet assembly 202 includes a hose hookup 56, a percent solids meter 58, a flow meter 60, and a conduit 62, as have been previously described herein, among other components as have been previously described herein.

In the arrangement shown, as one example, inlet assembly 202 is located near the forward end 12 of system 10 and is positioned on top of support structure 44 of trailer 200. In the arrangement shown, as one example, inlet assembly 202 is also positioned adjacent first holding tank 204. However, inlet assembly 202 may be positioned at any other location and assembled in any other configuration in order to allow materials to enter into system 10 and monitor the rate of flow and characteristic of materials entering system 10.

While inlet assembly 202 and various components of inlet assembly 202 have been primarily described according to one or more arrangements shown, as one example, it will be understood by those skilled in the art that any other configuration of inlet assembly 202 and various components of inlet assembly 202 may be used in order to allow materials to enter into system 10 from a pond, lagoon, or tank and flow to first holding tank 204, and also monitor the rate of flow and characteristics of materials entering system 10.

### First Holding Tank 204:

In the arrangement shown, as one example, system 10 includes first holding tank 204. First holding tank 204 is formed of any suitable size, shape, and design and is configured to receive the flow of material entering system 10 through inlet assembly 202, decrease the rate of flow of material before it moves through other components of system 10, and remove large waste material before it moves through other components of system 10. In the arrangement shown, as one example, first holding tank 204 includes a frame 222, a front wall 224, a back wall 226, opposing sidewalls 228, a floor 230, an auger conveyor 232, an outlet pipe 234, a pump 236, and a conduit 238.

Frame 222: In the arrangement shown, as one example, first holding tank 204 includes frame 222. Frame 222 is formed of any suitable size, shape, and design and is configured to provide structural support to first holding tank 204. In the arrangement shown as one example, frame 222 is formed of multiple pieces that are connected or assembled to one another through welding, however any other means of connecting or assembling the multiple pieces may be used, including bolting, screwing, riveting, friction fitting, or the like. Alternatively, frame 222 may be formed of a single, unitary member that is formed in a manufacturing process such as machining, extrusion, forming, additive manufacturing, laser cutting, or the like to form a unitary and monolithic member. In the arrangement shown, as one example, frame 222 is formed primarily of a metallic material such as steel, aluminum, chromium, or any other metallic material, alloy, and/or composite thereof. Alternatively, frame 222 may be formed of a non-metallic material such as a plastic material, a fiberglass material, or any other non-metallic material and/or composite thereof.

In the arrangement shown, as one example, frame 222 includes vertical members 240 and horizontal members 242. In the arrangement shown, as one example, vertical members 240 extend vertically around the exterior of first holding tank 204. In other words, in the arrangement shown, as one example, vertical members 240 extend vertically and are positioned on the outside of front wall 224, back wall 226, and opposing sidewalls 228 to provide structural support to front wall 224, back wall 226, and opposing sidewalls 228. In the arrangement shown, as one example, horizontal members 242 extend horizontally and connect to each of the vertical members 240 at both the top and bottom ends of vertical members 240, thereby operably connecting all of the vertical members 240. In the arrangement shown, as one example, the horizontal members 242 connected to the top ends of vertical members 240 also connects to the exterior of first holding tank 204, or said another, to the outside of front wall 224, back wall 226, and opposing sidewalls 228, thereby providing structural support to front wall 224, back wall 226, and opposing sidewalls 228.

Front Wall 224: In the arrangement shown, as one example, first holding tank 204 includes front wall 224. Front wall 224 is formed of any suitable size, shape, and design and is configured to help contain material that enters first holding tank 204. In the arrangement shown, as one example, front wall 224 is a generally rectangular or square, planar member which extends a height between opposing ends and a length between opposing sides. In the arrangement shown, as one example, front wall 224 connects at one end to one of the opposing sidewall 228 and front wall 224 connects at the opposing end to the other opposing sidewall 228.

In the arrangement shown as one example, front wall 224 is formed of a single, unitary member that is formed in a manufacturing process such as machining, extrusion, forming, additive manufacturing, laser cutting, or the like to form a unitary and monolithic member. Alternatively, front wall 224 may be formed of multiple pieces that are connected or assembled to one another through bolting, screwing, welding, friction fitting, or the like. In the arrangement shown, as one example, front wall 224 is formed primarily of a metallic material such as steel, aluminum, chromium, or any other metallic material, alloy, and/or composite thereof. Alternatively, front wall 224 may be formed of a non-metallic material such as a plastic material, a fiberglass material, or any other non-metallic material and/or composite thereof.

Back Wall 226: In the arrangement shown, as one example, first holding tank 204 includes back wall 226. Back wall 226 is formed of any suitable size, shape, and design and is configured to help contain material that enters first holding tank 204. In the arrangement shown, as one example, back wall 226 is a generally rectangular or square, planar member which extends a height between opposing ends and a length between opposing sides. In the arrangement shown, as one example, back wall 226 connects at one end to one of the opposing sidewall 228 and back wall 226 connects at the opposing end to the other opposing sidewall 228.

In the arrangement shown as one example, back wall 226 is formed of a single, unitary member that is formed in a manufacturing process such as machining, extrusion, forming, additive manufacturing, laser cutting, or the like to form a unitary and monolithic member. Alternatively, back wall 226 may be formed of multiple pieces that are connected or assembled to one another through bolting, screwing, welding, friction fitting, or the like. In the arrangement shown, as one example, back wall 226 is formed primarily of a metallic material such as steel, aluminum, chromium, or any other metallic material, alloy, and/or composite thereof. Alternatively, back wall 226 may be formed of a non-metallic material such as a plastic material, a fiberglass material, or any other non-metallic material and/or composite thereof.

Opposing Sidewalls 228: In the arrangement shown, as one example, first holding tank 204 includes opposing sidewalls 228. Opposing sidewalls 228 are formed of any suitable size, shape, and design and is configured to help contain material that enters first holding tank 204. In the arrangement shown, as one example, opposing sidewalls 228 are generally rectangular, planar members which extend a height between opposing ends and a length between opposing sides. In the arrangement shown, as one example, opposing sidewalls 228 connect at one end to front wall 224 and opposing sidewalls 228 at the opposing end to back wall 226.

In the arrangement shown as one example, opposing sidewalls 228 are formed of a single, unitary member that is formed in a manufacturing process such as machining, extrusion, forming, additive manufacturing, laser cutting, or the like to form a unitary and monolithic member. Alternatively, opposing sidewalls 228 may be formed of multiple pieces that are connected or assembled to one another through bolting, screwing, welding, friction fitting, or the like. In the arrangement shown, as one example, opposing sidewalls 228 are formed primarily of a metallic material such as steel, aluminum, chromium, or any other metallic material, alloy, and/or composite thereof. Alternatively, opposing sidewalls 228 may be formed of a non-metallic material such as a plastic material, a fiberglass material, or any other non-metallic material and/or composite thereof.

Floor 230: In the arrangement shown, as one example, first holding tank 204 includes floor 230. Floor 230 is formed of any suitable size, shape, and design and is configured to help contain material that enters first holding tank 204 and direct the material towards opening 250 in order to exit first holding tank 204. In the arrangement shown as one example, floor 230 is formed of multiple pieces that are connected or assembled to one another through welding, however any other means of connecting or assembling the multiple pieces may be used, including bolting, screwing, riveting, friction fitting, or the like. Alternatively, floor 230 may be formed of a single, unitary member that is formed in a manufacturing process such as machining, extrusion, forming, additive manufacturing, laser cutting, or the like to form a unitary and monolithic member. In the arrangement shown, as one example, floor 230 is formed primarily of a metallic material such as steel, aluminum, chromium, or any other metallic material, alloy, and/or composite thereof. Alternatively, floor 230 may be formed of a non-metallic material such as a plastic material, a fiberglass material, or any other non-metallic material and/or composite thereof.

In the arrangement shown, as one example, floor 230 includes multiple sloped portions 246, a recess 248, and an opening 250. In the arrangement shown, as one example, the sloped portions 246 of floor 230 of first holding tank 204 is configured to direct material towards recess 248. In the arrangement shown, as one example, sloped portions 246 slope downward and inward towards each other and effectively meet at recess 248. In the arrangement shown, as one example, floor 230 includes opening 250 in one of the sloped portions 246. In the arrangement shown, as one example, opening 250 is configured to allow liquid to flow through opening 250 and into conduit 238 in order to exit first holding tank 204. In the arrangement shown, as one example, this sloped configuration of floor 230 allows primarily solids to flow down sloped portions 246 to recess 248 and then to auger conveyor 232, while primarily liquids exit first holding tank 204 through opening 250. In the arrangement shown, as one example, a portion of auger conveyor 232 is positioned within recess 248 of floor 230.

Auger Conveyor 232: In the arrangement shown, as one example, first holding tank 204 includes auger conveyor 232. Auger conveyor 232 is formed of any suitable size, shape, and design and is configured to remove solids from the material that enters first holding tank 204. In the arrangement shown, as one example, auger conveyor 232 may be a Sand Cannon Separator and/or Sand Recovery System from DariTech Inc., however any other type of auger conveyor or similar device may be used as auger conveyor 232. In the arrangement shown, as one example, auger conveyor 232 includes a trough 252, a cover 254, a support arm 256, a shaft 258, flighting 260, and a motor 262.

In the arrangement shown, as one example, auger conveyor 232 is angled upward and away from trailer 200. In the arrangement shown, as one example, auger conveyor 232 operates to carry solid material up auger conveyor 232 and eventually away from trailer 200 while liquid is allowed to run back down auger conveyor 232. In the arrangement shown, as one example, the trough 252 is configured to prevent material from falling out of auger conveyor 232 as the shaft 258 and flighting 260 operate to move solid material up auger conveyor 232.

In the arrangement shown, as one example, auger conveyor 232 includes a trough 252. Trough 252 is formed of any suitable size, shape, and design and is configured to provide a channel to hold material within auger conveyor 232. In the arrangement shown, as one example, trough 252 is an elongated, semi-circular member which extends between opposing ends. In the arrangement shown, as one example, the semi-circular shape of trough 252 forms opposing side walls and a bottom surface in order to hold material within auger conveyor 232. In the arrangement shown, as one example, trough 252 is configured to connect to cover 254 in order to at least partially enclose shaft 258 and flighting 260 of auger conveyor 232.

In the arrangement shown, as one example, auger conveyor 232 includes cover 254. Cover 254 is formed of any suitable size, shape, and design and is configured to help hold material within auger conveyor 232 and at least partially enclose shaft 258 and flighting 260 to increase safety of auger conveyor 232. In the arrangement shown, as one example, cover 254 is a generally elongated, rectangular member with a hollow center, which allows the shaft 258 and flighting 260 to extend through auger conveyor 232 between trough 252 and cover 254. In the arrangement shown, as one example, cover 254 connects to trough 252 through bolting, riveting, wending, or any other process of joining two member together. In the arrangement shown, as one example, cover 254 also connects to support arm 256.

In the arrangement shown, as one example, auger conveyor 232 includes support arm 256. Support arm 256 is formed of any suitable size, shape, and design and is configured to help auger conveyor 232 stay angled upward and outward from trailer 200. In the arrangement shown, as one example, support arm 256 connects at one end to one of the opposing sidewalls 228 of first holding tank 204 and at its other end to cover 254. In this way, support arm 256 helps to facilitate connection between first holding tank 204 and auger conveyor 232, and this connection helps hold auger conveyor 232 in an upward and outward angled position relative to trailer 200. In one or more arrangements, as examples, portions of auger conveyor 232 may be detachable from first holding tank 204 in order to comply with road travel restrictions. In the arrangement shown, as one example, support arm 256 is detachable from first holding tank 204 and cover 254 in order to allow the detaching of a portion of auger conveyor 232.

In the arrangement shown, as one example, auger conveyor 232 includes a shaft 258, flighting 260, and motor 262. Shaft 258 is formed of any suitable size, shape, and design and is configured to extend through the center of flighting 260 and engage flighting 260 within close and tight tolerances. In the arrangement shown, as one example, shaft 258 connects to motor 262. Motor 262 is formed of any suitable size, shape, and design and is configured to facilitate the rotation of shaft 258. In the arrangement shown, as one example, when shaft 258 rotates, the tight engagement between shaft 258 and flighting 260 causes flighting 260 to rotate with shaft 258.

Flighting 260 is formed of any suitable size, shape, and design and is configured to facilitate the movement of material (primarily solids) upward and eventually out of auger conveyor 232 in order to remove material (primarily solids) from first holding tank 204. In the arrangement shown, as one example, flighting 260 is an elongated, helical member which may be formed of a single piece of material or may be formed of multiple pieces of material (such as angled disks) connected to one another in order to form flighting 260. In the arrangement shown, as one example, when flighting 260 is caused to rotate due to the rotation of shaft 258, the helical nature of flighting 260 forces material (primarily solids) which are in contact with flighting 260 to move upward along auger conveyor 232.

In the arrangement shown, as one example, trough 252 and cover 254 partially enclose shaft 258 and flighting 260. However, shaft 258 and flighting 260 extend past both ends of trough 252 and cover 254 such that each end of shaft 258 and flighting 260 are uncovered and open to the elements. In the arrangement shown, as one example, one end of shaft 258 and flighting 260 rest within recess 248 of floor 230 of first holding tank 204 and cover 254 does not cover the top of shaft 258 and flighting 260. In this way, material (primarily solids) are able to flow into recess 248 and contact flighting 260. In the arrangement shown, as one example, the other end of shaft 258 and flighting 260 extend farther outward and upward than trough 252. In this way, solid which flows to the top of auger conveyor 232 can fall off the bottom of flighting 260 and into a waste disposal container 214 positioned below the end of auger conveyor 232.

In the arrangement shown, as one example, liquid which enters auger conveyor 232 is able to flow back down auger conveyor 232 as flighting rotates, thereby returning the liquid to first holding tank 204 in order to exit first holding tank 204 through opening 250. In the arrangement shown, as one example, the liquid flowing through opening 250 in floor 230 enters outlet pipe 234.

Outlet Pipe 234: In the arrangement shown, as one example, first holding tank 204 includes an outlet pipe 234. Outlet pipe 234 is formed of any suitable size, shape, and design and is configured to allow material to move from first holding tank 204 to separator assembly 206. In the arrangement shown, as one example, outlet pipe 234 is a generally cylindrical, hollow pipe which extends between opposing ends. In the arrangement shown, as one example, the first end of outlet pipe 234 connects to opening 250 of floor 230 of first holding tank 204, such that material flowing through opening 250 enters outlet pipe 234. In the arrangement shown, as one example, the second end of outlet pipe 234 connects to pump 236 of first holding tank 204, which propels the material flowing through outlet pipe 234 to separator assembly 206.

In the arrangement shown as one example, outlet pipe 234 is formed of a single, unitary member that is formed in a manufacturing process such as machining, extrusion, forming, additive manufacturing, laser cutting, or the like to form a unitary and monolithic member. Alternatively, outlet pipe 234 may be formed of multiple pieces that are connected or assembled to one another through coupling, welding, friction fitting, or the like. In the arrangement shown, as one example, outlet pipe 234 is formed primarily of a metallic material such as steel, aluminum, chromium, or any other metallic material, alloy, and/or composite thereof. Alternatively, outlet pipe 234 may be formed of a non-metallic material such as a plastic material, a fiberglass material, or any other non-metallic material and/or composite thereof.

Pump 236: In the arrangement shown, as one example, first holding tank 204 includes pump 236. Pump 236 is formed of any suitable size, shape, and design and is configured to pump material flowing through outlet pipe 234 of first holding tank 204 to separator assembly 206. In the arrangement shown, as one example, pump 236 is a centrifugal pump, however any other type or configuration of pump capable of pumping material to separator assembly 206 may be used as pump 236. In the arrangement shown, as one example, materials flowing through outlet pipe 234 enter pump 236. Once in pump 236, impellers (now shown) within pump 236 rotate and force the material within pump 236 outward and eventually out the top of pump 236 and into conduit 238.

Conduit 238: In the arrangement shown, as one example, first holding tank 204 includes conduit 238. Conduit 238 is formed of any suitable size, shape, and design and is configured to fluidly connect pump 236 of first holding tank 204 to the inlet pipe 274 of separator assembly 206. In the arrangement shown, as one example, conduit 238 is a generally cylindrical pipe with a hollow center which allows fluid to move through conduit 238. In the arrangement shown, as one example, conduit 238 connects at one end to pump 236 and at its second end to the inlet pipe 274 of separator assembly 206.

While first holding tank 204 and various components of first holding tank 204 have been primarily described according to one or more arrangements shown, as one example, it will be understood by those skilled in the art that any other configuration of first holding tank 204 and various components of first holding tank 204 may be used in order to receive the flow of material entering system 10 through inlet assembly 202, decrease the rate of flow of material before it moves through other components of system 10, and remove large waste material before it moves through other components of system 10.

### Separator Assembly 206:

In the arrangement shown, as one example, system 10 includes separator assembly 206. Separator assembly 206 is formed of any suitable size, shape, and design and is configured to facilitate separation of liquids from solids. In the arrangement shown, as one example, separator assembly 206 includes a separator 266, an outlet pipe 268, a pump 270, and a conduit 272.

Separator 266: In the arrangement shown, as one example, separator assembly 206 includes separator 266. Separator 266 is formed of any suitable size, shape, and design and is configured to facilitate the separation of solids from liquids. In the arrangement shown, as one example, separator 266 may be a DT360 manure separator produced and sold by Daritech Inc. In the arrangement shown, as one example, separator 266 has a 48 inch drum. In one or more arrangements, separator 266 may be a rotary screen separator such as the hybrid rotary screen separator shown and described in U.S. Patent Publication No. 2011/0198268 or the hybrid rotary screen separator shown and described in U.S. Pat. No. 10,286,340, both of which are herein incorporated by reference in their entireties. However, any other type of separator, including any type of manure separator, rotary drum separator, or any other type of separator manufactured, offered, or produced by any entity may be used and is hereby contemplated for use as separator 266.

In the arrangement shown, as one example, there is one separator 266, however any other number of separators 266 may be used including one, two, three, four, five, or more separators 266. Without limiting the foregoing, in the arrangement shown, as one example, separator 266 includes an inlet pipe 274, a housing 276, a drive belt 278, and a motor 280.

In the arrangement shown, as one example, separator 266 includes an inlet pipe 274. Inlet pipe 274 is formed of any suitable size, shape, and design and is configured to connect to conduit 238 of first holding tank 204 in order to allow material to enter into separator 266. In the arrangement shown, as one example, inlet pipe 274 is a generally cylindrical, elongated tube which connects at one end to conduit 238 and has a second end which extends into housing 276 past forward end 282 and allows material to enter housing 276.

In the arrangement shown, as one example, separator 266 includes housing 276. Housing 276 is formed of any suitable size, shape, and design and is configured to house the internal components of separator 266 and support additional components of separator 266. In the arrangement shown, as one example, when viewed from top side 18 of system 10, housing 276 is a generally rectangular member extending a length between a forward end 282 and a rearward end 284, and a width between opposing sidewalls 286. In the arrangement shown, as one example, when viewed from forward end 12 of system 10, housing 276 is generally octagonal in shape and extends a length between opposing sidewalls 286 and a height between an upper wall 288 and a lower wall 290, and when viewed from forward end 12 of system 10 housing 276 includes a generally hollow interior. In the arrangement shown, as one example, when viewed from an opposing side 16 of system 10, housing 276 is generally rectangular in shape and extends a length between forward end 282 and rearward end 284, and a height between upper wall 288 and lower wall 290.

In the arrangement shown, as one example, housing 276 includes a rotating member 292 within the hollow interior of housing 276. Rotating member 292 is formed of any suitable size, shape, and design and is configured to rotate within the hollow interior of housing 276 in order to help separate liquids from solids. In the arrangement shown, as one example, rotating member 292 is generally circular in shape and extends from at or near the forward end 282 of housing 276 to at or near the rearward end 284 of housing 276. In the arrangement shown, as one example, rotating member 292 also connects to drive belt 278 and is driven (i.e. rotated) by drive belt 278 and motor 280.

In the arrangement shown, as one example, material that enters housing 276 through inlet pipe 274, falls into rotating member 292. In the arrangement shown, as one example, rotating member 292 has perforations (not shown) which allow liquid and fine solid materials to fall through rotating member 292 and into drain pan 294. In the arrangement shown, as one example, when material falls into rotating member 292, the perforations allow liquid and fine solid materials to fall through the perforations in rotating member 292 and into drain pan 294, thereby separating liquid from solids. In the arrangement shown, as one example, the interior surface of rotating member 292 includes helical protrusions and, when rotating member 292 is rotated, the helical protrusions cause material that does not drain through the perforations to move toward the rearward end 284 of housing 276 and eventually out of housing 276 and onto the first conveyor assembly 366 of roller press assembly 212.

In the arrangement shown, as one example, separator 266 includes a drive belt 278 and a motor 280. Drive belt 278 is formed of any suitable size, shape, and design and is configured to connect to rotating member 292 and motor 280 and transfer the rotation of motor 280 to rotating member 292. In the arrangement shown, as one example, drive belt 278 may be any brand, material, specification, configuration, or size of drive belt known in the art. Motor 280 is formed of any suitable size, shape, and design and is configured to facilitate the rotational movement of rotating member 292. In the arrangement shown, as one example, motor 280 may be an electric motor or engine, or motor 280 may be a gas powered motor or engine, diesel powered motor or engine, solar powered motor, or any other type of motor, engine, or power source capable of facilitating rotational movement of rotating member 292.

In the arrangement shown, as one example, housing 276 includes drain pan 294. Drain pan 294 is formed of any suitable size, shape, and design and is configured to catch liquids and fine solid materials that fall through the perforations of rotating member 292 and direct the fluid to conduit 272. In the arrangement shown, as one example, drain pan 294 rests below rotating member 292 and is a generally elongated, rectangular member with an open top allowing the liquid falling through rotating member 292 to enter into drain pan 294. In the arrangement shown, as one example, the bottom or floor of drain pan 294 may be sloped in order to direct water toward and into outlet pipe 268.

In the arrangement shown, as one example, separator assembly 206 includes an outlet pipe 268. Outlet pipe 268 is formed of any suitable size, shape, and design and is configured to facilitate removal of fluid and fine solid materials from drain pan 294 of housing 276 of separator 266. In the arrangement shown, as one example, outlet pipe 268 extends outward from drain pan 294 at one end and connect at its other end to pump 270 of separator assembly 206.

Pump 270: In the arrangement shown, as one example, separator assembly 206 includes pump 270. Pump 270 is formed of any suitable size, shape, and design and is configured to pump the material flowing through outlet pipe 234 through conduit 238 and into second holding tank 208. In the arrangement shown, as one example, pump 270 is a centrifugal pump, however any other type or configuration of pump capable of pumping material to second holding tank 208 may be used as pump 270. In the arrangement shown, as one example, materials flowing through outlet pipe 268 enter pump 270. Once in pump 270, impellers (now shown) within pump 270 rotate and force the material within pump 270 outward and eventually out the top of pump 270 and into conduit 272.

Conduit 272: In the arrangement shown, as one example, first holding tank 204 includes conduit 272. Conduit 272 is formed of any suitable size, shape, and design and is configured to fluidly connect pump 270 of separator assembly 206 to second holding tank 208. In the arrangement shown, as one example, conduit 272 is a generally cylindrical pipe with a hollow center which allows fluid to move through conduit 272. In the arrangement shown, as one example, conduit 272 connects at one end to pump 270 and the second end of conduit 272 extends upward and over one of the opposing sidewalls of second holding tank 208 in order to deposit the material flowing through conduit 272 into second holding tank 208.

While separator assembly 206 and various components of separator assembly 206 have been primarily described according to one or more arrangements shown, as one example, it will be understood by those skilled in the art that any other configuration of separator assembly 206 and various components of separator assembly 206 may be used in order to facilitate separation of liquids from solids.

### Second Holding Tank 208:

In the arrangement shown, as one example, system 10 includes second holding tank 208. Second holding tank 208 is formed of any suitable size, shape, and design and is configured to receive and hold material therein. In the arrangement shown, as one example, second holding tank 208 is separated into a first portion 302 and a second portion 304. In the arrangement shown, as one example, the first portion 302 is configured to receive the flow of liquid and fine solid material from separator assembly 206 and decrease the rate of flow of material before it moves to hydrocyclone assembly 210. In the arrangement shown, as one example, the second portion 304 of separator assembly is configured to receive the flow of liquid (including less than 1% total dissolved solids) which exit hydrocyclone assembly 210 and hold such liquid until it is ready to be returned to the tank, lagoon, pond, or similar liquid container from which the material was originally pumped. In the arrangement shown, as one example, second holding tank 208 also includes a frame 300.

Frame 300: In the arrangement shown, as one example, second holding tank 208 includes frame 300. Frame 300 is formed of any suitable size, shape, and design and is configured to provide structural support to second holding tank 208. In the arrangement shown as one example, frame 300 is formed of multiple pieces that are connected or assembled to one another through welding, however any other means of connecting or assembling the multiple pieces may be used, including bolting, screwing, riveting, friction fitting, or the like. Alternatively, frame 300 may be formed of a single, unitary member that is formed in a manufacturing process such as machining, extrusion, forming, additive manufacturing, laser cutting, or the like to form a unitary and monolithic member. In the arrangement shown, as one example, frame 300 is formed primarily of a metallic material such as steel, aluminum, chromium, or any other metallic material, alloy, and/or composite thereof. Alternatively, frame 300 may be formed of a non-metallic material such as a plastic material, a fiberglass material, or any other non-metallic material and/or composite thereof.

In the arrangement shown, as one example, frame 300 includes vertical members 306 and horizontal members 308. In the arrangement shown, as one example, vertical members 306 extend vertically around the exterior of second holding tank 208. In other words, in the arrangement shown, as one example, vertical members 306 extend vertically and are positioned on the outside of front wall 326, back wall 310, and opposing sidewalls 312 to provide structural support to front wall 326, back wall 310, and opposing sidewalls 312. In the arrangement shown, as one example, horizontal members 308 extend horizontally and connect to each of the vertical members 306 at both the top and bottom ends of vertical members 306, thereby operably connecting all of the vertical members 306. In the arrangement shown, as one example, the horizontal members 308 connected to the top ends of vertical members 306 also connects to the exterior of second holding tank 208, or said another way, to the outside of front wall 326, back wall 310, and opposing sidewalls 312, thereby providing structural support to front wall 326, back wall 310, and opposing sidewalls 312.

First Portion 302: In the arrangement shown, as one example, second holding tank 208 includes first portion 302. First portion 302 is formed of any suitable size, shape, and design and is configured to receive the flow of liquid and fine solid material from separator assembly 206 and decrease the rate of flow of material before it moves to hydrocyclone assembly 210. In the arrangement shown, as one example, first portion 302 includes back wall 310, opposing sidewalls 312, a partition 314, floor 316, auger conveyor 318, and a first outlet pipe leading to pump 322, which connects to conduit 324.

Back Wall 310: In the arrangement shown, as one example, the first portion 302 of second holding tank 208 includes back wall 310. Back wall 310 is formed of any suitable size, shape, and design and is configured to help contain material that enters second holding tank 208. In the arrangement shown, as one example, back wall 310 is a generally rectangular or square, planar member which extends a height between opposing ends and a length between opposing sides. In the arrangement shown, as one example, back wall 310 connects at one end to one of the opposing sidewall 312 and back wall 310 connects at the opposing end to the other opposing sidewall 312.

In the arrangement shown as one example, back wall 310 is formed of a single, unitary member that is formed in a manufacturing process such as machining, extrusion, forming, additive manufacturing, laser cutting, or the like to form a unitary and monolithic member. Alternatively, back wall 310 may be formed of multiple pieces that are connected or assembled to one another through bolting, screwing, welding, friction fitting, or the like. In the arrangement shown, as one example, back wall 310 is formed primarily of a metallic material such as steel, aluminum, chromium, or any other metallic material, alloy, and/or composite thereof. Alternatively, back wall 310 may be formed of a non-metallic material such as a plastic material, a fiberglass material, or any other non-metallic material and/or composite thereof.

Opposing Sidewalls 312: In the arrangement shown, as one example, the first portion 302 of second holding tank 208 includes opposing sidewalls 312. Opposing sidewalls 312 are formed of any suitable size, shape, and design and is configured to help contain material that enters second holding tank 208. In the arrangement shown, as one example, opposing sidewalls 312 are generally rectangular, planar members which extend a height between opposing ends and a length between opposing sides. In the arrangement shown, as one example, opposing sidewalls 312 connect at one end to partition 314 and opposing sidewalls 312 at the opposing end to back wall 310.

In the arrangement shown as one example, opposing sidewalls 312 are formed of a single, unitary member that is formed in a manufacturing process such as machining, extrusion, forming, additive manufacturing, laser cutting, or the like to form a unitary and monolithic member. Alternatively, opposing sidewalls 312 may be formed of multiple pieces that are connected or assembled to one another through bolting, screwing, welding, friction fitting, or the like. In the arrangement shown, as one example, opposing sidewalls 312 are formed primarily of a metallic material such as steel, aluminum, chromium, or any other metallic material, alloy, and/or composite thereof. Alternatively, opposing sidewalls 312 may be formed of a non-metallic material such as a plastic material, a fiberglass material, or any other non-metallic material and/or composite thereof.

Partition 314: In the arrangement shown, as one example, the first portion 302 of second holding tank 208 includes partition 314. Partition 314 is formed of any suitable size, shape, and design and is configured to separate the material held in first portion 302 and the liquid held in second portion 304. In the arrangement shown, as one example, partition 314 is a generally rectangular, planar member which extends a height between opposing ends and a length between opposing sides. In the arrangement shown, as one example, partition 314 connects at one end to an opposing sidewall 312 and partition 314 connects at its other end to the other opposing sidewall 312.

In the arrangement shown as one example, partition 314 are formed of a single, unitary member that is formed in a manufacturing process such as machining, extrusion, forming, additive manufacturing, laser cutting, or the like to form a unitary and monolithic member. Alternatively, partition 314 may be formed of multiple pieces that are connected or assembled to one another through bolting, screwing, welding, friction fitting, or the like. In the arrangement shown, as one example, partition 314 are formed primarily of a metallic material such as steel, aluminum, chromium, or any other metallic material, alloy, and/or composite thereof. Alternatively, partition 314 may be formed of a non-metallic material such as a plastic material, a fiberglass material, or any other non-metallic material and/or composite thereof.

Floor 316: In the arrangement shown, as one example, second holding tank 208 includes floor 316. Floor 316 is formed of any suitable size, shape, and design and is configured to help contain material that enters second holding tank 208 and direct the material towards first opening 334 and first outlet pipe 320 in order to exit second holding tank 208. In the arrangement shown as one example, floor 316 is formed of multiple pieces that are connected or assembled to one another through welding, however any other means of connecting or assembling the multiple pieces may be used, including bolting, screwing, riveting, friction fitting, or the like. Alternatively, floor 316 may be formed of a single, unitary member that is formed in a manufacturing process such as machining, extrusion, forming, additive manufacturing, laser cutting, or the like to form a unitary and monolithic member. In the arrangement shown, as one example, floor 316 is formed primarily of a metallic material such as steel, aluminum, chromium, or any other metallic material, alloy, and/or composite thereof. Alternatively, floor 316 may be formed of a non-metallic material such as a plastic material, a fiberglass material, or any other non-metallic material and/or composite thereof.

In the arrangement shown, as one example, floor 316 includes multiple sloped portions 330, a recess 332, and an first opening 334. In the arrangement shown, as one example, the sloped portions 330 of floor 316 of second holding tank 208 is configured to direct material towards recess 332. In the arrangement shown, as one example, sloped portions 330 slope downward and inward towards each other and effectively meet at recess 332. In the arrangement shown, as one example, floor 316 includes first opening 334 in one of the sloped portions 330. In the arrangement shown, as one example, first opening 334 is configured to allow liquid to flow through first opening 334 and into first outlet pipe 320 in order to exit second holding tank 208. In the arrangement shown, as one example, this sloped configuration of floor 316 allows primarily solids to flow down sloped portions 330 to recess 332 and then to auger conveyor 318, while primarily liquids exit second holding tank 208 through first opening 334. In the arrangement shown, as one example, a portion of auger conveyor 318 is positioned within recess 332 of floor 316.

Auger Conveyor 318: In the arrangement shown, as one example, first portion 302 of second holding tank 208 includes auger conveyor 318. Auger conveyor 318 is formed of any suitable size, shape, and design and is configured to remove solids from the material that enters first portion 302 of second holding tank 208. In the arrangement shown, as one example, auger conveyor 318 may be a Sand Cannon Separator and/or Sand Recovery System from DariTech Inc., however any other type of auger conveyor or similar device may be used as auger conveyor 318. In the arrangement shown, as one example, auger conveyor 318 includes a trough 338, a cover 340, a support arm 342, a shaft 344, flighting 346, and a motor 348.

In the arrangement shown, as one example, auger conveyor 318 is angled upward and away from trailer 200. In the arrangement shown, as one example, auger conveyor 318 operates to carry solid material up auger conveyor 318 and eventually away from trailer 200 while liquid is allowed to run back down auger conveyor 318. In the arrangement shown, as one example, the trough 338 is configured to prevent material from falling out of auger conveyor 318 as the shaft 344 and flighting 346 operate to move solid material up auger conveyor 318.

In the arrangement shown, as one example, auger conveyor 318 includes a trough 338. Trough 338 is formed of any suitable size, shape, and design and is configured to provide a channel to hold material within auger conveyor 318. In the arrangement shown, as one example, trough 338 is an elongated, semi-circular member which extends between opposing ends. In the arrangement shown, as one example, the semi-circular shape of trough 338 forms opposing side walls and a bottom surface in order to hold material within auger conveyor 318. In the arrangement shown, as one example, trough 338 is configured to connect to cover 340 in order to at least partially enclose shaft 344 and flighting 346 of auger conveyor 318.

In the arrangement shown, as one example, auger conveyor 318 includes cover 340. Cover 340 is formed of any suitable size, shape, and design and is configured to help hold material within auger conveyor 318 and at least partially enclose shaft 344 and flighting 346 to increase safety of auger conveyor 318. In the arrangement shown, as one example, cover 340 is a generally elongated, rectangular member with a hollow center, which allows the shaft 344 and flighting 346 to extend through auger conveyor 318 between trough 338 and cover 340. In the arrangement shown, as one example, cover 340 connects to trough 338 through bolting, riveting, wending, or any other process of joining two member together. In the arrangement shown, as one example, cover 340 also connects to support arm 342.

In the arrangement shown, as one example, auger conveyor 318 includes support arm 342. Support arm 342 is formed of any suitable size, shape, and design and is configured to help auger conveyor 318 stay angled upward and outward from trailer 200. In the arrangement shown, as one example, support arm 342 connects at one end to one of the opposing sidewalls 312 of second holding tank 208 and at its other end to cover 340. In this way, support arm 342 helps to facilitate connection between second holding tank 208 and auger conveyor 318, and this connection helps hold auger conveyor 318 in an upward and outward angled position relative to trailer 200. In one or more arrangements, as examples, portions of auger conveyor 318 may be detachable from second holding tank 208 in order to comply with road travel restrictions. In the arrangement shown, as one example, support arm 342 is detachable from second holding tank 208 and cover 340 in order to allow the detaching of a portion of auger conveyor 318.

In the arrangement shown, as one example, auger conveyor 318 includes a shaft 344, flighting 346, and motor 348. Shaft 344 is formed of any suitable size, shape, and design and is configured to extend through the center of flighting 346 and engage flighting 346 within close and tight tolerances. In the arrangement shown, as one example, shaft 344 connects to motor 348. Motor 348 is formed of any suitable size, shape, and design and is configured to facilitate the rotation of shaft 344. In the arrangement shown, as one example, when shaft 344 rotates, the tight engagement between shaft 344 and flighting 346 causes flighting 346 to rotate with shaft 344.

Flighting 346 is formed of any suitable size, shape, and design and is configured to facilitate the movement of material (primarily solids) upward and eventually out of auger conveyor 318 in order to remove material (primarily solids) from second holding tank 208. In the arrangement shown, as one example, flighting 346 is an elongated, helical member which may be formed of a single piece of material or may be formed of multiple pieces of material (such as angled disks) connected to one another in order to form flighting 346. In the arrangement shown, as one example, when flighting 346 is caused to rotate due to the rotation of shaft 344, the helical nature of flighting 346 forces material (primarily solids) which are in contact with flighting 346 to move upward along auger conveyor 318.

In the arrangement shown, as one example, trough 338 and cover 340 partially enclose shaft 344 and flighting 346. However, shaft 344 and flighting 346 extend past both ends of trough 338 and cover 340 such that each end of shaft 344 and flighting 346 are uncovered and open to the elements. In the arrangement shown, as one example, one end of shaft 344 and flighting 346 rest within recess 332 of floor 316 of second holding tank 208 and cover 340 does not cover the top of shaft 344 and flighting 346. In this way, material (primarily solids) are able to flow into recess 332 and contact flighting 346. In the arrangement shown, as one example, the other end of shaft 344 and flighting 346 extend farther outward and upward than trough 338. In this way, solid which flows to the top of auger conveyor 318 can fall off the bottom of flighting 346 and into a waste disposal container 214 positioned below the end of auger conveyor 318.

In the arrangement shown, as one example, liquid which enters auger conveyor 318 is able to flow back down auger conveyor 318 as flighting 346 rotates, thereby returning the liquid to second holding tank 208 in order to exit second holding tank 208 through first opening 334. In the arrangement shown, as one example, the liquid flowing through first opening 334 in floor 316 enters first outlet pipe 320.

First Outlet Pipe 320: In the arrangement shown, as one example, second holding tank 208 includes a first outlet pipe 320. First outlet pipe 320 is formed of any suitable size, shape, and design and is configured to allow material to move from second holding tank 208 to hydrocyclone assembly 210. In the arrangement shown, as one example, first outlet pipe 320 is a generally cylindrical, hollow pipe which extends between opposing ends. In the arrangement shown, as one example, the first end of first outlet pipe 320 connects to first opening 334 of floor 316 of second holding tank 208, such that material flowing through first opening 334 enters first outlet pipe 320. In the arrangement shown, as one example, the second end of first outlet pipe 320 connects to pump 322 of second holding tank 208, which propels the material flowing through first outlet pipe 320 to hydrocyclone assembly 210.

In the arrangement shown as one example, first outlet pipe 320 is formed of a single, unitary member that is formed in a manufacturing process such as machining, extrusion, forming, additive manufacturing, laser cutting, or the like to form a unitary and monolithic member. Alternatively, first outlet pipe 320 may be formed of multiple pieces that are connected or assembled to one another through coupling, welding, friction fitting, or the like. In the arrangement shown, as one example, first outlet pipe 320 is formed primarily of a metallic material such as steel, aluminum, chromium, or any other metallic material, alloy, and/or composite thereof. Alternatively, first outlet pipe 320 may be formed of a non-metallic material such as a plastic material, a fiberglass material, or any other non-metallic material and/or composite thereof.

Pump 322: In the arrangement shown, as one example, second holding tank 208 includes pump 322. Pump 322 is formed of any suitable size, shape, and design and is configured to pump material flowing through first outlet pipe 320 of second holding tank 208 to hydrocyclone assembly 210. In the arrangement shown, as one example, pump 322 is a centrifugal pump, however any other type or configuration of pump capable of pumping material to hydrocyclone assembly 210 may be used as pump 322. In the arrangement shown, as one example, materials flowing through first outlet pipe 320 enter pump 322. Once in pump 322, impellers (now shown) within pump 322 rotate and force the material within pump 322 outward and eventually out the top of pump 322 and into conduit 324.

Conduit 324: In the arrangement shown, as one example, second holding tank 208 includes conduit 324. Conduit 324 is formed of any suitable size, shape, and design and is configured to fluidly connect pump 322 of second holding tank 208 to the inlet 350 of hydrocyclone assembly 210. In the arrangement shown, as one example, conduit 324 is a generally cylindrical pipe with a hollow center which allows fluid to move through conduit 324. In the arrangement shown, as one example, conduit 324 connects at one end to pump 322 and at its second end to the inlet 350 of hydrocyclone assembly 210.

Once the fluid moves through hydrocyclone assembly 210 (as described in more detail below), liquid flows out of hydrocyclone assembly 210 through outlet pipe 362. In the arrangement shown, as one example, the liquid flowing out of hydrocyclone assembly 210 through outlet pipe 362 enters the second portion 304 of second holding tank 208.

Second Portion 304: In the arrangement shown, as one example, second holding tank 208 includes second portion 304. Second portion 304 is formed of any suitable size, shape, and design and is configured to receive the flow of liquid (including less than 1% total dissolved solids) which exit hydrocyclone assembly 210 and hold such liquid until it is ready to be returned to the tank, lagoon, pond, or similar liquid container from which the material was originally pumped. In the arrangement shown, as one example, second portion 304 is formed, in part, of opposing sidewalls 312 and partition 314, which have been previously disclosed herein. In the arrangement shown, as one example, second portion 304 is formed, in part, of front wall 326 and second outlet pipe 328.

Front Wall 326: In the arrangement shown, as one example, second holding tank 208 includes front wall 326. Front wall 326 is formed of any suitable size, shape, and design and is configured to help contain material that enters second holding tank 208. In the arrangement shown, as one example, front wall 326 is a generally rectangular or square, planar member which extends a height between opposing ends and a length between opposing sides. In the arrangement shown, as one example, front wall 326 connects at one end to one of the opposing sidewall 312 and front wall 326 connects at the opposing end to the other opposing sidewall 312.

In the arrangement shown as one example, front wall 326 is formed of a single, unitary member that is formed in a manufacturing process such as machining, extrusion, forming, additive manufacturing, laser cutting, or the like to form a unitary and monolithic member. Alternatively, front wall 326 may be formed of multiple pieces that are connected or assembled to one another through bolting, screwing, welding, friction fitting, or the like. In the arrangement shown, as one example, front wall 326 is formed primarily of a metallic material such as steel, aluminum, chromium, or any other metallic material, alloy, and/or composite thereof. Alternatively, front wall 326 may be formed of a non-metallic material such as a plastic material, a fiberglass material, or any other non-metallic material and/or composite thereof.

In the arrangement shown, as one example, second portion 304 is also partially formed by floor 316, as previously described herein. In the arrangement shown, as one example, the portion of the floor 316 which is in second portion 304 includes a second opening 336. Second opening 336 is formed of any suitable size, shape, and design and is configured to allow liquid to flow through second opening 336 and into second outlet pipe 328 in order to exit second holding tank 208 and be returned to the tank, lagoon, pond, or similar liquid container from which the material was originally pumped.

Second Outlet Pipe 328: In the arrangement shown, as one example, second portion 304 of second holding tank 208 includes a second outlet pipe 328. Second outlet pipe 328 is formed of any suitable size, shape, and design and is configured to allow material to move from second holding tank 208 back to the tank, lagoon, pond, or similar liquid container from which the material was originally pumped. In the arrangement shown, as one example, second outlet pipe 328 is a generally cylindrical, hollow pipe which extends between opposing ends. In the arrangement shown, as one example, the first end of second outlet pipe 328 connects to second opening 336 of floor 316 of second holding tank 208, such that material flowing through second opening 336 enters second outlet pipe 328. In the arrangement shown, as one example, the second end of second outlet pipe 328 may lead back to the tank, lagoon, pond, or similar liquid container from which the material was originally pumped. Alternatively, in one or more arrangements, as examples, the second end of second outlet pipe 328 may connect to a hose system or other pump or propulsion system which sends the liquid back to the tank, lagoon, pond, or similar liquid container from which the material was originally pumped.

While second holding tank 208 and various components of second holding tank 208 have been primarily described according to one or more arrangements shown, as one example, it will be understood by those skilled in the art that any other configuration of second holding tank 208 and various components of second holding tank 208 may be used in order to receive and hold material therein.

### Hydrocyclone Assembly 210:

In the arrangement shown, as one example, system 10 includes hydrocyclone assembly 210. Hydrocyclone assembly 210 is formed of any suitable size, shape, and design and is configured to separate fine solid materials from liquid. More specifically, hydrocyclone assembly 210 is configured to separate fine solids from liquid. In the arrangement shown, as one example, hydrocyclone assembly 210 includes one or more hydrocyclones 352. Specifically, in the arrangement shown, as one example, hydrocyclone assembly 210 includes an inlet 350 and three hydrocyclones 352.

Inlet 350: In the arrangement shown, as one example, hydrocyclone assembly 210 includes inlet 350. Inlet 350 is formed of any suitable size, shape, and design and is configured to connect hydrocyclone 352 to conduit 324 of first portion 302 of second holding tank 208. In the arrangement shown, as one example, inlet 350 includes four openings (not shown). In the arrangement shown, as one example, a first opening connects to conduit 324 such that fluid flowing through conduit 324 may enter inlet 350. In the arrangement shown, as one example, each of the other openings connect to each of three hydrocyclones 352 of hydrocyclone assembly 210. In one or more alternative arrangements, as examples, inlet 350 may have any other numbers of openings in order to allow inlet 350 to connect to conduit 324 and each of the hydrocyclones 352 of hydrocyclone assembly 210.

In the arrangement shown, as one example, fluid flowing through conduit 324 enters inlet 350 through the opening which allows conduit 324 to connect to inlet 350. In the arrangement shown, as one example, the fluid then flows through inlet 350 until it reaches an opening connected to a hydrocyclone 352, then the fluid enters such hydrocyclone 352. In this way, inlet 350 operably connects conduit 324 and each of the hydrocyclones 352 in order for fluid leaving the first portion 302 of second holding tank 208 to enter hydrocyclones 352.

Hydrocyclones 352: In the arrangement shown, as one example, hydrocyclone assembly 210 includes one or more hydrocyclones 352. Hydrocyclones 352 are formed of any suitable size, shape, and design and are configured to separate solids from liquids. More specifically, in the arrangement shown as one example, hydrocyclones 352 are configured to remove fine solid material from the liquid that exits separator 266. In the arrangement shown, as one example, hydrocyclones 352 are McLanahan® Hydrocyclones, however any other hydrocyclone, cyclonic separator, or other type of separator may be used and is hereby contemplated for use as hydrocyclone 352 in order to remove fine solid material that exits separator 266 from the liquid that exits separator 266. In the arrangement shown, as one example, each hydrocyclone 352 includes a feed box 354, a cone 356, a spigot 358, a regulator 360, and an outlet pipe 362.

In the arrangement shown, as one example, hydrocyclone 352 includes a feed box 354. Feed box 354 is formed of any suitable size, shape, and design and is configured to receive material from inlet 350 and connect to cone 356. In the arrangement shown, as one example, feed box 354 is positioned near the upper side of hydrocyclone 352 and includes an opening which is configured to connect to inlet 350 in order to allow material to flow into hydrocyclone 352. In the arrangement shown, as one example, feed box 354 is a generally cylindrical member which connects to the top of cone 356 and includes a hollow interior which aligns with the hollow interior of cone 356. In the arrangement shown, as one example, the material entering feed box 354 travels in a centrifugal manner down feed box 354 and into cone 356.

In the arrangement shown, as one example, hydrocyclone 352 includes cone 356. Cone 356 is formed of any suitable size, shape, and design and is configured to help increase the speed of centrifugal rotation of materials in hydrocyclone 352. In the arrangement shown, as one example, when viewed from forward end 12, rearward end 14, or a side 16, cone 356 is generally in the shape of an inverted triangle, with an upper end that is generally wider and a lower end which is narrow and nearly forms a point. In the arrangement shown, as one example, when viewed from top side 18 or bottom side 20 of system 10, cone 356 is generally circular and has a hollow interior. In the arrangement shown, as one example, the material entering through feed box 354 falls into cone 356 while still moving in a centrifugal manner.

In the arrangement shown, as one example, hydrocyclone 352 includes a spigot 358 and regulator 360. Spigot 358 is formed of any suitable size, shape, and design and is configured to allow coarse material to exit out the bottom of hydrocyclone 352. In the arrangement shown, as one example, spigot 358 is simply an opening in the bottom of cone 356. Regulator 360 is formed of any suitable size, shape, and design and is configured to group together the coarse materials at spigot 358 and allow the coarse solid materials to fall only when the solid materials have a specific size or volume. In the arrangement shown, as one example, the solid materials that exit hydrocyclone 352 through spigot 358 must fall a ways before it reaches the first conveyor assembly 366 of roller press assembly 212. In the arrangement shown, as one example, regulator 360 prevents the solid materials from falling out of spigot 358 under there is a sufficiently sized grouping of solid materials that will fall to reaches the first conveyor assembly 366 of roller press assembly 212 without being broken up and/or blown away by wind.

In the arrangement shown, as one example, the material enters the feed box 354 of hydrocyclone 352 with a predetermined pressure and in a centrifugal manner. That is, in the arrangement shown, as one example, the material entering hydrocyclone 352 tends to be forced toward the walls of feed box 354 and cone 356 and the predetermined pressure at which the material enters feed box 354 determines how strong the centrifugal force that acts on the material entering into feed box 354. In the arrangement shown, as one example, the heavier materials are generally forced further outward to the walls of feed box 354 and cone 356 and the liquids and extremely fine solid materials generally stay suspended toward the middle of feed box 354 and cone 356. As the heavier materials drops lower into cone 356, the shape of cone 356 forces the rotation of the heavier material to speed up, which creates a vortex. In the arrangement shown, as one example, the vortex formed causes the liquids and extremely fine solid materials suspended toward the middle of feed box 354 and cone 356 to travel upwards and eventually out of hydrocyclone 352 through outlet pipe 362.

Outlet Pipe 362: In the arrangement shown, as one example, hydrocyclone assembly 210 includes outlet pipe 362. Outlet pipe 362 is formed of any suitable size, shape, and design and is configured to allow liquids and extremely fine solid materials to exit hydrocyclone 352 and travel to the second portion 304 of second holding tank 208. In the arrangement shown, as one example, a first end of outlet pipe 362 connects to the top of feed box 354, and more specifically an opening in the top of feed box 354 such that liquid and extremely fine solid materials forced out of hydrocyclone 352 enters outlet pipe 362. In the arrangement shown, as one example, the second end of outlet pipe 362 rests directly above the second portion 304 of second holding tank 208 and the material flowing through outlet pipe 362 falls into the second portion 304 of second holding tank 208.

In the arrangement shown as one example, outlet pipe 362 is formed of a single, unitary member that is formed in a manufacturing process such as machining, extrusion, forming, additive manufacturing, laser cutting, or the like to form a unitary and monolithic member. Alternatively, outlet pipe 362 may be formed of multiple pieces that are connected or assembled to one another through coupling, welding, friction fitting, or the like. In the arrangement shown, as one example, outlet pipe 362 is formed primarily of a metallic material such as steel, aluminum, chromium, or any other metallic material, alloy, and/or composite thereof. Alternatively, outlet pipe 362 may be formed of a non-metallic material such as a plastic material, a fiberglass material, or any other non-metallic material and/or composite thereof.

While hydrocyclone assembly 210 and various components of hydrocyclone assembly 210 have been primarily described according to one or more arrangements shown, as one example, it will be understood by those skilled in the art that any other configuration of hydrocyclone assembly 210 and various components of hydrocyclone assembly 210 may be used in order to separate fine solid materials from liquid.

### Roller Press Assembly 212:

In the arrangement shown, as one example, system 10 includes roller press assembly 212. Roller press assembly 212 is formed of any suitable size, shape, and design and is configured to squeeze out liquid from solid material that has been separated by separator assembly 206 of hydrocyclone assembly 210. In the arrangement shown, as one example, roller press assembly 212 includes a first conveyor assembly 366, a roller press 368, and a second conveyor assembly 370.

First Conveyor Assembly 366: In the arrangement shown, as one example, roller press assembly 212 includes first conveyor assembly 366. First conveyor assembly 366 is formed of any suitable size, shape, and design and is configured to catch the solid material separated by separator 266 and by hydrocyclones 352 and transfer such material to roller press 368. In the arrangement shown, as one example, first conveyor assembly 366 is a belt conveyor, however any other type or configuration of conveyor may be used in order to catch material separated by separator 266 and by hydrocyclones 352 and transfer such material to roller press 368.

In the arrangement shown, as one example, first conveyor assembly 366 includes side walls configured to contain the material that falls onto first conveyor assembly 366. In the arrangement shown, as one example, with the side walls containing material on first conveyor assembly 366, rollers (not shown) of the first conveyor assembly 366 rotate which causes a belt (not shown) to rotate as well. The rotation of the belt causes material to move past a side edge of trailer 200, and when the material reaches the end of the belt, the material falls off first conveyor assembly 366 and into roller press 368.

Roller Press 368: In the arrangement shown, as one example, roller press assembly 212 includes roller press 368. Roller press 368 is formed of any suitable size, shape, and design and is configured to remove liquid from solid material and store and/or return such liquid until such time as it can be reused. In the arrangement shown, as one example, roller press 368 includes a frame 372, an inlet 374, a motor 376, a first roller 378, a second roller 380, and a drain pan (not shown).

In the arrangement shown, as one example, roller press 368 includes a frame 372. Frame 372 is formed of any suitable size, shape, and design and is configured to connect to and support the various components of roller press 368. More specifically, in the arrangement shown, as one example, frame 372 operably connects to and supports each of the motor 376, first roller 378, second roller 380, and the drain pan. Further, frame 372 forms a part of inlet 374.

In the arrangement shown, as one example, frame 372 includes sidewalls 382, a backwall 384, and bottom members 386. In the arrangement shown, as one example, sidewalls 382 form the sides of frame 372 and operably connect to motor 376, first roller 378, and second roller 380. In the arrangement shown, as one example, sidewalls 382 each meet with backwall 384. In the arrangement shown, as one example, backwall 384 forms the back side of frame 372. In the arrangement shown, as one example, each of sidewalls 382 and backwall 384 meet with bottom members 386 in order to engage the ground or floor where roller press assembly 212 is located and provide stability and support to roller press assembly 212.

In the arrangement shown, as one example, frame 372 forms a part of inlet 374. That is, in the arrangement shown, as one example, sidewalls 382 and backwall 384 meet to form a partially enclosed rectangular member. In the arrangement shown, as one example, inlet 374 includes a floor 388. Floor 388 of inlet 374 connects at its ends to sidewalls 382 and at its backside to backwall 384. In the arrangement shown, as one example, floor 388 extends forward and at an angle downward from backwalls 384 until it reaches first roller 378 and second roller 380.

In the arrangement shown, as one example, roller press 368 includes a motor 376. Motor 376 is formed of any suitable size, shape, and design and is configured to facilitate the rotational movement of first roller 378. In the arrangement shown, as one example, motor 376 may be an electric motor or engine, or motor 376 may be a gas powered motor or engine, diesel powered motor or engine, solar powered motor, or any other type of motor, engine, or power source capable of facilitating rotational movement of first roller 378.

In the arrangement shown, as one example, roller press 368 includes a first roller 378 and second roller 380. First roller 378 is formed of any suitable size, shape, and design and is configured to rotate, engage the material moving down the angled floor 388 of inlet 374, and squeeze liquid out of such material. Second roller 380 is formed of any suitable size, shape, and design and is configured to engage the material moving down the angled floor 388 of inlet 374, and squeeze liquid out of such material.

In the arrangement shown, as one example, first roller 378 is positioned such that it is nearly in contact with second roller 380. In the arrangement shown, as one example, material moving down the angled floor 388 of inlet 374 is engaged by first roller 378 and the rotation of first roller 378 moves the material once it comes in contact with first roller 378. As the material moves with first roller 378, it is pressed tightly between first roller 378 and second roller 380, thereby squeezing liquid out of the material.

In the arrangement shown, as one example, roller press 368 includes a drain pan. The drain pan of roller press 368 is formed of any suitable size, shape, and design and is configured to capture the liquid squeezed out of the material entering roller press 368. In various arrangements, as examples, the drain pan of roller press 368 includes an opening which connects to a pipe, hose, or other conduit with a pump and the liquid from the drain pan of roller press 368 may be returned to the second holding tank 208 in order for the liquid to be further process and/or sent back to the tank, lagoon, pond, or similar liquid container from which the material was originally pumped.

In the arrangement shown, as one example, the solid material pressed between first roller 378 and second roller 380 falls off and onto second conveyor assembly 370.

Second Conveyor Assembly 370: In the arrangement shown, as one example, roller press assembly 212 includes second conveyor assembly 370. Second conveyor assembly 370 is formed of any suitable size, shape, and design and is configured to move solid material pressed by roller press 368 to a waste disposal container 214. In the arrangement shown, as one example, second conveyor assembly 370 is a belt conveyor, however any other type or configuration of conveyor may be used in order to move solid material pressed by roller press 368 to a waste disposal container 214.

In the arrangement shown, as one example, second conveyor assembly 370 includes side walls configured to contain the material on second conveyor assembly 370. In the arrangement shown, as one example, with the side walls containing material on second conveyor assembly 370, rollers (not shown) of the second conveyor assembly 370 rotate which causes a belt (not shown) to rotate as well. The rotation of the belt causes material to move upward and farther outward from trailer 200, and when the material reaches the end of the belt, the material falls off second conveyor assembly 370 and into a waste disposal container 214.

### Waste Disposal Containers 214:

In the arrangement shown, as one example, system 10 includes waste disposal containers 214. Waste disposal containers 214 are formed of any suitable size, shape, and design and are configured to facilitate disposal of the solid materials separated from liquid using system 10. In 10 the arrangement shown, as one example, waste disposal containers 214 are roll off containers, however in various other arrangements waste disposal containers 214 may be dumpsters or any other type of container configured to collect and facilitate disposal of waste material. In the arrangement shown, as one example, there is one waste disposal container 214, however any other number of waste disposal containers 214 may be used including, one, two, three, four, five, or more waste disposal containers 214.

While waste disposal containers 214 have been primarily described according to one or more arrangements shown, as one example, it will be understood by those skilled in the art that any other configuration of waste disposal containers 214 may be used in order to facilitate disposal of the solid materials separated from liquid using system 10.

### Power Source 216:

In the arrangement shown, as one example, system 10 includes a power source 216. Power source 216 is formed of any suitable size, shape, and design and is configured to provide power to system 10 and various components of system 10 including separator 266, as well as auger conveyor 232 of first holding tank 204, auger conveyor 318 of second holding tank 208, pump 236 of first holding tank 204, pump 270 of separator assembly 206, and pump 322 of first portion 302 of second holding tank 208. In the arrangement shown, as one example, power source 216 is a gas powered generator, however any other type of generator or power source may be used as power source 216 including, but not limited to, a diesel powered generator, a solar powered generator or engine, a gas powered engine, a diesel powered engine, or any other source of power.

### Control System 218:

In the arrangement shown, as one example, system 10 may also include a control system 218. Control system 218 is formed of any suitable size, shape, and design and is configured to facilitate control of system 10 and its various components. In the arrangement shown, as one example, control system 218 may include sensors that monitor the water levels in first holding tank 204, first portion 302 of second holding tank 208, and/or the second portion 304 of second holding tank 208. In the arrangement shown, as one example, if a sensor on first holding tank 204, the first portion 302 of second holding tank 208, and/or second portion 304 of second holding tank 208 is full, the sensor will send a signal to control system 218. At this point, the user may manually shut off the robot cleaner so no more material enters system 10 and causes a tank to overflow, or control system 218 may receive the signal from the sensor and, through circuitry and instructions programmed into control system 218, control system 218 may automatically shut off the robot cleaner.

In the arrangement shown, as one example, control system 218 may be used in order to control the various pumps and view readouts from the various monitors in system 10. That is, in the arrangement shown, as one example, control system 218 may be used in order to control the output characteristics (rate of flow, volume, pressure, etc.) of pump 236 of first holding tank 204, pump 270 of separator assembly 206, and pump 322 of first portion 302 of second holding tank 208, and control system 218 may control each of these pumps independently of the other pumps. Additionally or alternatively, in the arrangement shown, as one example, control system 218 may be used in order to monitor the readouts from percent solids meter 58 and flow meter 60 in order to determine if there are any malfunctions in the robot cleaner or the hose or hose system which is pumping materials to system 10.

### In Operation:

In one or more arrangements, as examples, system 10 may be used to separate liquids from solids. In one or more arrangements, as examples, solids, liquids, and sludge suctions off the floor of a tank, lagoon, pond, or similar liquid container using a robot cleaner. In one or more arrangements, as examples, the robot cleaner is connected to system 10 through a hose or hose assembly. In the arrangement shown, as one example, the hose or hose assembly connects to inlet assembly 202. In the arrangement shown, as one example, solid, liquid, and sludge material flows into inlet assembly 202 through hose hookup 56 and the rate of flow and percent of solids flowing into inlet assembly 202 are measured using flow meter 60 and percent solids meter 58, respectively. In the arrangement shown, as one example, after the materials flow through percent solids meter 58 and flow meter 60, the material flows through conduit 62 and into first holding tank 204.

In the arrangement shown, as one example, material flowing into first holding tank 204 moves down the sloped portions 246 of floor 230. In the arrangement shown, as one example, as the material moves down the sloped portions 246 of floor 230, some of the liquid in the materials which enter first holding tank 204 flows through opening 250 in floor 230. In the arrangement shown, as one example, the rest of the material moves down the sloped portions 246 until it reaches recess 248 of floor 230. In the arrangement shown, as one example, when the material reaches recess 248, it comes in contact with flighting 260 of auger conveyor 232.

In the arrangement shown, as one example, motor 262 of auger conveyor 232 operates to cause shaft 258 to rotate, which causes flighting 260 to rotate. In the arrangement shown, as one example, flighting 260 is configured such that when flighting 260 rotates, solid material that comes in contact with the rotating flighting 260 is moved upward along auger conveyor 232. In the arrangement shown, as one example, as the solid material moves upward along auger conveyor 232, liquid that moves partway up the auger conveyor 232 with the solid material is able to flow back down auger conveyor 232, such that only solid material is moved to the end of auger conveyor 232. Once the solid material nears the end of auger conveyor 232, trough 252 ends prior to flighting 260 ends. When the solid material reaches the point where trough 252 ends, the solid material slides off the bottom of flighting 260 and falls into waste disposal containers 214 positioned below the end of auger conveyor 232.

In the arrangement shown, as one example, as previously mentioned, liquid that enters first holding tank 204 is able to flow through opening 250 of floor 230. As liquid flows through opening 250 of floor 230, it enters outlet pipe 234. Once the liquid enters outlet pipe 234 of first holding tank 204, it flows to pump 236 of first holding tank 204. Once the fluid reaches pump 236, pump 236 pumps the liquid and solid material through conduit 238 until it enters separator 266 through inlet pipe 274.

In the arrangement shown, as one example, inlet pipe 274 directs the material into the housing 276 of separator 266, and more specifically onto rotating member 292. When the material is in the housing 276 of separator 266, the motor 280 of separator 266 causes the drive belt 278 of separator 266 to rotate. In the arrangement shown, as one example, drive belt 278 is operably connected to and partially wrapped around a portion of rotating member 292 of housing 276 of separator 266. In the arrangement shown, as one example, the rotation of drive belt 278 causes rotating member 292 to rotate as well. In the arrangement shown, as one example, as the material falls into rotating member 292, liquid and fine solid materials fall through the perforations of rotating member 292 and into drain pan 294.

In the arrangement shown, as one example, as rotating member 292 rotates, the coarse waste material which is prevented from falling into drain pan 294 moves toward the rearward end 284 of housing 276 by the helical protrusions on the interior surface of rotating member 292. In the arrangement shown, as one example, when the coarse waste material reaches rearward end 284 of housing 276, the course waste material drops off the edge of housing 276 and onto first conveyor assembly 366 of roller press assembly 212.

In the arrangement shown, as one example, the liquid and fine solids material that falls into drain pan 294 flows out of drain pan 294 through outlet pipe 268 of separator assembly 206. In the arrangement shown, as one example, the liquid and fine solids material that flow through outlet pipe 268 reaches pump 270 of separator assembly 206. In the arrangement shown, as one example, pump 270 then pumps the liquid and fine solids material into and through conduit 272 of separator assembly 206, which drains into the first portion 302 of second holding tank 208.

In the arrangement shown, as one example, the fluids and fine solids material that flows through conduit 272 then flows into the first portion 302 of second holding tank 208. In the arrangement shown, as one example, the second end of conduit 272 is positioned near the top end of second holding tank 208 and the fluids and fine solids material falls out of the second end of conduit 272 and into the first portion 302 of second holding tank 208. In the arrangement shown, as one example, when the liquids and fine solids material are in the first portion 302 of second holding tank 208, the liquids and fine solids material move down the sloped portions 330 of floor 316. In the arrangement shown, as one example, as the material moves down the sloped portions 330 of floor 316, some of the liquid and find solids in the materials flow through first opening 334 of the floor 316 in first portion 302. In the arrangement shown, as one example, the rest of the material moves down the sloped portions 330 until it reaches recess 332 of floor 316. In the arrangement shown, as one example, when the material reaches recess 332, it comes in contact with flighting 346 of auger conveyor 318.

In the arrangement shown, as one example, motor 348 of auger conveyor 318 operates to cause shaft 344 to rotate, which causes flighting 346 to rotate. In the arrangement shown, as one example, flighting 346 is configured such that when flighting 346 rotates, solid material that comes in contact with the rotating flighting 346 is moved upward along auger conveyor 318. In the arrangement shown, as one example, as the solid material moves upward along auger conveyor 318, liquid that moves partway up the auger conveyor 318 with the solid material is able to flow back down auger conveyor 318, such that only solid material is moved to the end of auger conveyor 318. Once the solid material nears the end of auger conveyor 318, trough 338 ends prior to flighting 346 ends. When the solid material reaches the point where trough 338 ends, the solid material slides off the bottom of flighting 346 and falls into waste disposal containers 214 positioned below the end of auger conveyor 232.

In the arrangement shown, as one example, as previously mentioned, liquid and fine solid material that enters the first portion 302 of second holding tank 208 is able to slow through first opening 334 of floor 316. As liquid flows through first opening 334 of floor 316, it enters first outlet pipe 320 and flows to pump 322 of first portion 302 of second holding tank 208. Once the fluid reaches pump 322, pump 322 pumps the liquid and fine solid material through conduit 324 until it enters hydrocyclone assembly 210 through inlet 350.

In the arrangement shown, as one example, once the liquid and fine solid material enter inlet 350, the liquid and fine solid material is split between three hydrocyclones 352. In the arrangement shown, as one example, inlet 350 connects to the feed box 354 of each hydrocyclone 352 and the liquid and fine solids material flowing through inlet 350 enter into hydrocyclones 352 through the respective feed boxes 354.

In the arrangement shown, as one example, pump 322 is configured to pump the liquid and fine solids material at a certain speed and pressure such that the liquid and fine solids material enter into hydrocyclones 352 at a predetermined rate, volume, and/or pressure. In the arrangement shown, as one example, the rate, volume, and/or pressure at which the liquid and fine solids material enter into hydrocyclones 352 determines the size (dimension and/or density) of material that is separated from the liquid using hydrocyclones 352. In the arrangement shown, as one example, when the liquid and fine solids material enter feed box 354 they begin to move down feed box 354 and into cone 356 in a centrifugal motion which causes the solid materials to be forced outward. As the solid materials are forced outward, the liquids and extremely fine solid materials remain toward the middle of feed box 354 and/or cone 356.

In the arrangement shown, as one example, as the solid materials continue to move down through cone 356 in a centrifugal motion, the speed at which the solid materials move downward and rotate is increased. In the arrangement shown, as one example, this increase in speed of downward movement and rotation causes a vortex to form in hydrocyclones 352. In the arrangement shown, as one example, the vortex formed causes the liquids and extremely fine solid materials suspended toward the middle of feed box 354 and cone 356 to travel upwards and eventually out of hydrocyclones 352 through outlet pipes 362. In the arrangement shown, as one example, the solids materials which are not force up and out of hydrocyclones 352 continue to move downward until they reach spigot 358. In the arrangement shown, as one example, once the solid materials reach spigot 358, regulator 360 temporarily blocks the solid materials from falling out of spigot 358 until a sufficient amount of solid materials is at spigot 358, at which point the regulator 360 gives way and allows the solids material to fall out of hydrocyclones 352 and onto first conveyor assembly 366 of roller press assembly 212.

In the arrangement shown, as one example, the material that falls onto first conveyor assembly 366 move along the belt of first conveyor assembly 366 until it falls off the end. In the arrangement shown, as one example, the material then enters inlet 374 of roller press 368. In the arrangement shown, as one example, the material slides down the angled floor 388 of inlet 374 until it engages first roller 378 and/or second roller 380. In the arrangement shown, as one example, once the material engages first roller 378, the rotation of first roller 378 causes the material to be squeezed between first roller 378 and second roller 380, thereby removing liquid from the material. In the arrangement shown, as one example, the material that moves through first roller 378 and second roller 380 then falls onto the second conveyor assembly 370, which operates to move the material to a waste disposal container 214. In the arrangement shown, as one example, the liquid squeezed out of the material enters the drain pan of the roller press assembly 212, where it is stored or returned to the second holding tank 208.

In the arrangement shown, as one example, the liquid and extremely fine solids material that are pulled out of hydrocyclones 352 through outlet pipes 362 drain into the second portion 304 of second holding tank 208. In the arrangement shown, as one example, the liquid and extremely fine solids material rest in the second portion 304 of second holding tank 208 until second opening 336 of floor 316 is opened, allowing the liquid (with less than 1% total dissolved solids back to the tank, lagoon, pond, or similar liquid container) to enter into second outlet pipe 328. In the arrangement shown, as one example, second outlet pipe 328 may lead back to the tank, lagoon, pond, or similar liquid container from which the material was originally pumped. Alternatively, in one or more arrangements, as examples, the second end of second outlet pipe 328 may connect to a hose system or other pump or propulsion system which sends the liquid back to the tank, lagoon, pond, or similar liquid container from which the material was originally pumped. In this way, system 10 operates to separate solids from liquids and return liquids (with less than 1% total dissolved solids back to the tank, lagoon, pond, or similar liquid container.

### Additional Attachments:

In one or more arrangements, as examples, system 10 may also include various other components such as driers configured to dry the solid waste materials separated by separator 266 and hydrocyclones 352. Additionally or alternatively, in one or more arrangements, system 10 may include more separators and various other types of separators, depending on the specifications of the job needed to be completed. It will be understood by those of skill in the art that various other types of separators, driers, and material processing equipment may be attached to and used in system 10 and such additional components are hereby contemplated for use with system 10.

From the above discussion it will be appreciated that the system 10 presented herein improves upon the state of the art. Specifically, in one or more arrangements, a dewatering trailer system 10 is presented which: improves upon the state of the art; is safe to operate; is able to comply with road travel restrictions; is easily and efficiently moved around to various locations; is relatively easy to build; is relatively friendly to build; can be built relatively quickly and efficiently; is easy to operate; is relatively cost friendly to manufacture; is relatively easy to transport; is aesthetically appealing; is robust; is water resistant; is relatively inexpensive; is not easily susceptible to wear and tear; has a long useful life; and/or is efficient to use and operate.

What is claimed:

1. A system for separating solids and liquids from a pond, lagoon, tank, or other source of liquid, they system comprising:
a robot cleaner;
a trailer;
wherein the trailer is mobile;
a dewatering system;
wherein the dewatering system is configured to operably connect to the trailer;
wherein the robot cleaner is configured to fluidly connect to the dewatering system;
wherein the robot cleaner is configured to pump solids and liquids from a pond, lagoon, tank, or other source of liquid to the dewatering system;
wherein the dewatering system is configured to separate solids from the liquids;
wherein the dewatering system is configured to transfer separated solids away from the dewatering system;
wherein the dewatering system is configured to return liquids to the pond, lagoon, tank, or other source of liquid.

2. The system of claim 1 wherein the solids include total suspended solids and total dissolved solids, wherein the total suspended solids are separated from the liquids, wherein approximately 99% of total dissolved solids are separated from the liquids, wherein the separated total suspended solids and total dissolved solids are transported away, and wherein the liquid flows to a holding tank.

3. The system of claim 1 wherein the robot cleaner is fluidly connected to the dewatering system by a hose.

4. The system of claim 1 wherein the system for cleaning the pond, lagoon, tank, or other source of liquid is a continuous loop feed.

5. The system of claim 1 further comprising:
the dewatering system having at least one separator;
wherein the at least one separator is configured to separate solids from the liquids.

6. The system of claim 1 further comprising:
the dewatering system having at least one separator;
wherein the at least one separator is configured to separate solids from the liquids;
wherein the at least one separator is a rotary screen separator.

7. The system of claim 1 further comprising:
the dewatering system having at least one separator;
wherein the at least one separator is configured to separate solids from the liquids;
wherein the at least one separator is a hydrocyclone.

8. The system of claim 1 wherein the dewatering system is configured to operate at a rate of 600 gallons per minute.

9. The system of claim 1 wherein the separated solids are transported away by a conveyor belt.

10. A system for separating solids and liquids from a pond, lagoon, tank, or other source of liquid, the system comprising:
a robot cleaner;
a trailer;
wherein the trailer is mobile;
a dewatering system;
the dewatering system having at least one separator;
wherein the dewatering system is configured to operably connect to the trailer;
wherein the robot cleaner is configured to fluidly connect to the dewatering system;
wherein the robot cleaner is configured to pump solids and liquids from a pond, lagoon, tank, or other source of liquid to the dewatering system;
wherein the at least one separator is configured to separate solids from the liquids;
wherein the dewatering system is configured to transfer separated solids away from the dewatering system;
wherein the dewatering system is configured to return liquids to the pond, lagoon, tank, or other source of liquid.

11. The system of claim 10 wherein the solids include total suspended solids and total dissolved solids, wherein the total suspended solids are separated from the liquids, wherein approximately 99% of total dissolved solids are separated from the liquids, wherein the separated total suspended solids and total dissolved solids are transported away, and wherein the liquid flows to a holding tank.

12. The system of claim 10 wherein the robot cleaner is fluidly connected to the dewatering system by a hose.

13. The system of claim 10 wherein the system for cleaning the pond, lagoon, tank, or other source of liquid is a continuous loop feed.

14. The system of claim 10 wherein the at least one separator is a rotary screen separator.

15. The system of claim 10 wherein the at least one separator is a hydrocyclone.

16. The system of claim 10 wherein the dewatering system is configured to operate at a rate of 600 gallons per minute.

17. The system of claim 10 wherein the separated solids are transported away by a conveyor belt.

18. A system for separating solids and liquids from a pond, lagoon, tank, or other source of liquid, they system comprising:
a robot cleaner;
a trailer;
wherein the trailer is mobile;
a dewatering system;
the dewatering system having a first separator;
the dewatering system having a second separator;
wherein the dewatering system is configured to operably connect to the trailer;
wherein the robot cleaner is configured to fluidly connect to the dewatering system;
wherein the robot cleaner is configured to pump solids and liquids from a pond, lagoon, tank, or other source of liquid to the dewatering system;
wherein the first separator is configured to separate solids from the liquids;
wherein the second separator is configured to separate solids from the liquids;
wherein the dewatering system is configured to transfer separated solids away from the dewatering system;
wherein the dewatering system is configured to return liquids to the pond, lagoon, tank, or other source of liquid.

19. The system of claim 18 wherein the solids include total suspended solids and total dissolved solids, wherein the total suspended solids are separated from the liquids, wherein approximately 99% of total dissolved solids are separated from the liquids, wherein the separated total suspended solids and total dissolved solids are transported away, and wherein the liquid flows to a holding tank.

20. The system of claim 18 wherein the robot cleaner is fluidly connected to the dewatering system by a hose.

21. The system of claim 18 wherein the system for cleaning the pond, lagoon, tank, or other source of liquid is a continuous loop feed.

22. The system of claim 18 wherein the first separator is a rotary screen separator.

23. The system of claim 18 wherein the second separator is a hydrocyclone.

24. The system of claim 18 wherein the dewatering system is configured to operate at a rate of 600 gallons per minute.

25. The system of claim 18 wherein the separated solids are transported away by a conveyor belt.

26. A system for separating solids and liquids from a pond, lagoon, tank, or other source of liquid, they system comprising:
a trailer;
wherein the trailer is mobile;
at least one separator;
wherein the at least one separator is configured to operably connect to the trailer;
wherein solids and liquids enter the at least one separator;
wherein the at least one separator is configured to separate the solids and the liquids;
wherein the solids that are separated by the at least one separator are transported away;
wherein liquid from the at least one separator flows to a holding tank;
wherein the trailer is configured to be transported between various locations.

27. The system of claim 26 wherein the solids include total suspended solids and total dissolved solids, wherein the total suspended solids are separated from the liquids, wherein approximately 99% of total dissolved solids are separated from the liquids, wherein the total suspended solids and the total dissolved solids separated from the liquids are transported away prior to reaching the holding tank.

28. The system of claim 26 wherein liquid is pumped to the at least one separator by a robot cleaner.

29. The system of claim 26 wherein the at least one separator is a rotary screen separator.

30. The system of claim 26 wherein the at least one separator is a hydrocyclone.

31. The system of claim 26 wherein the at least one separator includes a rotary screen separator and a hydrocyclone.

32. The system of claim 26 wherein the separated solids are transported away by a conveyor belt.

33. The system of claim 26 wherein the solids and liquids are pumped into the at least one separator from a pond, lagoon, tank, or other source of liquid.

34. The system of claim 26 wherein the system is configured to operate at a rate of 600 gallons per minute.

35. The system of claim 26 wherein the system is a continuous loop feed.

36. The system of claim 26 wherein the solids and liquids are pumped into the at least one separator from a pond, lagoon, tank, or other source of liquid, and wherein the liquid in the holding tank is pumped back into the pond, lagoon, tank, or other source of liquid.
